(19) United States
(12) Patent Application Publication
(10) Pub. No.: US 2025/0390308 A1
(43) Pub. Date: Dec. 25, 2025

(54) METHODS, APPARATUS, AND ARTICLES OF MANUFACTURE TO SCHEDULE ALGORITHMS BASED ON CHARACTERISTICS OF DATA

(71) Applicant: Openchip & Software Technologies S.L., Barcelona (ES)

(72) Inventors: Francesc Guim Bernat, Barcelona (ES); Edgar Gonzalez Pellicer, Girona (ES); Ignacio Astilleros Diez, Madrid (ES)

(21) Appl. No.: 19/313,420

(22) Filed: Aug. 28, 2025

Related U.S. Application Data
(63) Continuation of application No. PCT/EP2025/061054, filed on Apr. 23, 2025.

(51) Int. Cl. G06F 9/30; H04L 9/08; H04L 9/32

(52) U.S. Cl. CPC G06F 9/3013; H04L 9/0816; H04L 9/3247

(57) ABSTRACT

Systems, apparatus, articles of manufacture, and methods are disclosed to schedule algorithms based on characteristics of data. An example compute device includes circuitry to determine at least one characteristic of a data object to be processed and adjust metadata associated with the data object to indicate that the data object has the at least one characteristic. Additionally, the example compute device includes machine-readable instructions and at least one programmable circuit to be programmed by the machine-readable instructions to select at least one of two or more programmable circuits to process the data object based on (a) at least one service level objective associated with the data object, (b) the metadata associated with the data object, and (c) telemetry data associated with the two or more programmable circuits.

### RELATED APPLICATION(S)

This patent arises from a continuation of International Patent Application No. PCT/EP2025/061054, which was filed on Apr. 23, 2025. Priority to International Patent Application No. PCT/EP2025/061054 is hereby claimed. International Patent Application No. PCT/EP2025/061054 is incorporated herein by reference in its entirety.

### STATEMENT REGARDING GOVERNMENT SUPPORT

The work leading to this invention has received funding from the European Union-Next Generation, Important Projects of Common European Interest (IPCEI). In particular, this invention was made with government support under Grant UNICO-IPCEI-2023-001 funded by the European Union-Next Generation IPCEI.

### FIELD OF THE DISCLOSURE

This disclosure relates generally to data processing and, more particularly, to methods, apparatus, and articles of manufacture to schedule algorithms based on characteristics of data.

### BACKGROUND

Many different types of data exist in computer processing. For example, data can be categorized as sparse data or dense data. Additionally or alternatively, data can be categorized based on what the data represents such as image data (e.g., color image data, black and white image data, etc.), medical device data (e.g., X-ray image data, pulse oximeter data, etc.), and/or telecommunications data (e.g., phone call data, text message data, etc.). In computer processing, many different algorithms exist to process data. For example, in artificial intelligence (AI) and/or machine learning (ML) applications, many different AI/ML models exist such as convolutional neural networks (CNNs), recurrent neural networks (RNNs), and long short-term memory (LSTM) networks, among others. Each type of AI/ML model may be implemented via many different types of architectures. Furthermore, the code to implement an algorithm (e.g., a given AI/ML model having a given architecture) may vary depending on the hardware (e.g., a central processor unit (CPU), a graphics processor unit (GPU), a field programmable gate array (FPGA), etc.) on which the algorithm is to be executed and/or instantiated.

### BRIEF DESCRIPTION OF THE DRAWINGS

FIG. 1 is a block diagram of an example processing flow of an algorithm to detect a person using assistive logos.

FIG. 2 is a block diagram of an example processing flow of an algorithm for facial recognition.

FIG. 3 is a block diagram of an example system including an example compute device in communication with an example data provider to receive and analyze an example data object to improve processing of the data object at the compute device.

FIG. 4 is a block diagram of the system of FIG. 3 depicting an example implementation of the programmable circuitry, the caching agent circuitry, the memory controller circuitry, and the load balancer circuitry of FIG. 3.

FIG. 5 is a block diagram of the system of FIG. 3 depicting an example data structure of an example data object of FIG. 3.

FIG. 6 is a flowchart representative of example machine-readable instructions and/or example operations that may be executed, instantiated, and/or performed by example programmable circuitry to implement the input/output (I/O) network circuitry of FIGS. 3-5.

FIG. 7A is a flowchart representative of example machine-readable instructions and/or example operations that may be executed, instantiated, and/or performed by example programmable circuitry to implement the load balancer circuitry of FIGS. 3-5 to schedule an algorithm to process a data object.

FIG. 7B is a flowchart representative of example machine-readable instructions and/or example operations that may be executed, instantiated, and/or performed by example programmable circuitry to implement the load balancer circuitry of FIGS. 3-5 to respond to a request for at least one data object having a target characteristic.

FIG. 8 illustrates an example hardware arrangement of an example data center.

FIG. 9A illustrates an example arrangement of an example chip assembly of FIG. 8

FIG. 9B illustrates an example arrangement of an example chip assembly of FIG. 8, adapted for high-performance computing applications.

FIG. 10 is a block diagram of an example processing platform including programmable circuitry structured to execute, instantiate, and/or perform the example machine-readable instructions and/or perform the example operations of FIGS. 6, 7A, and 7B to implement the I/O network circuitry, the programmable circuitry, the caching agent circuitry, the memory controller circuitry, and/or the load balancer circuitry of FIGS. 3 and/or 4.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine-readable instructions of FIGS. 6, 7A, and 7B) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Processing data is complicated by many factors. For example, many different types of data exist in computer processing and certain algorithms may be better suited to process certain types of data and/or to render certain results from the data than other algorithms. Data can be categorized as sparse data or dense data. Sparsity refers to an amount of zeros in data. For example, sparse data includes more zero-valued elements than non-zero-valued elements (e.g., 51% zero-valued elements and 49% non-zero-valued elements). Also, for example, dense data includes more non-zero-valued elements than zero-valued elements (e.g., 51% non-zero-valued elements and 49% zero-valued elements). A level of sparsity of data refers to the percentage of the data that is represented by zero bits.

Additionally, data can be categorized based on the format in which the data is stored (e.g., as an array, as a linked list, as a tree, as a matrix, as a graph, etc.). Data can also be categorized based on what the data represents such as image data (e.g., color image data, black and/or white image data, etc.), medical device data (e.g., X-ray image data, pulse oximeter data, etc.), and telecommunications data (e.g., phone call data, text message data, etc.), among others. Depending on the type of data to be processed and/or the desired processing to be performed on the data, one algorithm may be better suited to process the data than another algorithm.

For example, many different algorithms exist to process data. Different algorithms can be categorized based on a goal or task to be achieved by the algorithm. Different types of algorithms include prediction algorithms (e.g., decision trees, time series models, etc.), optimization algorithms (e.g., gradient descent, Newton's method, etc.), pattern recognition algorithms (e.g., template matching, statistical techniques, neural networks (NNs), deep learning models, etc.), and data transformation algorithms (e.g., data cleansing, filtering, normalization, etc.), among others. In AI/ML applications, many different AI/ML models exist such as CNNs, RNNs, LSTM networks, deep belief networks (DBNs), autoencoder networks, encoder-decoder networks, generative adversarial networks (GANs), radial basis function networks (RBFNs), and multilayer perceptron (MLP) networks, among others. Each type of AI/ML model may be implemented via many different types of architectures.

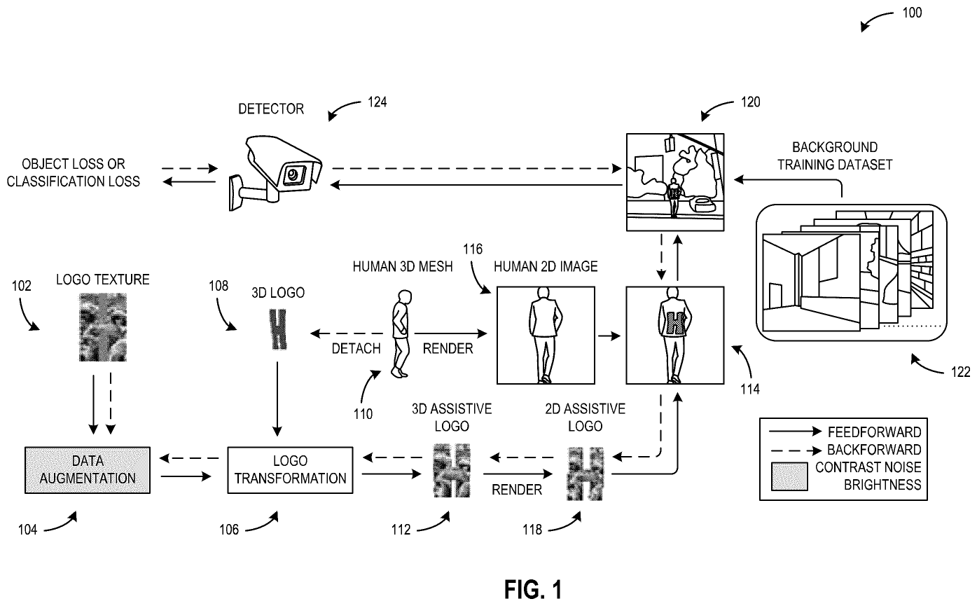

FIG. 1 is a block diagram of an example processing flow 100 of an algorithm to detect a person using assistive logos. In the example of FIG. 1, the processing flow 100 includes an example assistive logo selection stage 102 in which the algorithm selects a logo texture image. A logo texture image refers to a structured two-dimensional (2D) patch in an arbitrary shape. For example, the logo texture image of FIG. 1 is a color image in the shape of the letter H. In the example of FIG. 1, the processing flow 100 includes an example data augmentation stage 104 in which the algorithm augments the brightness, contrast, and/or noise of the logo texture image.

In the illustrated example of FIG. 1, the processing flow 100 includes an example logo transformation stage 106 in which the algorithm detaches an example three-dimensional (3D) logo 108 from an example 3D mesh 110 of a person, maps the 3D logo 108 to the logo texture image via 2D texture mapping, and assigns color information from the logo texture image to the 3D logo 108 to produce an example 3D assistive logo 112. For example, a 3D mesh refers to a digital representation of a 3D object that uses vertices, edges, and faces to define the shape and structure of the 3D object. In the example of FIG. 1, the 3D assistive logo 112 refers to a structured 3D patch that, when appended to the 3D mesh 110 and rendered into a 2D image, is intended to consistently aid in detection of the 3D mesh 110 by object detection algorithms.

In the illustrated example of FIG. 1, the processing flow 100 includes an example differential rendering stage 114 in which the algorithm renders together the 3D mesh 110 and the 3D assistive logo 112 to synthesize an example 2D image 116 and an example 2D assistive logo 118. In the example of FIG. 1, the processing flow 100 includes an example training data generation stage 120 in which the algorithm synthesizes the 2D image 116 and the 2D assistive logo 118 with one or more background images 122 to generate one or more training and/or testing images. The one or more training and/or testing images can be processed by an example detector algorithm 124 to determine object loss or classification loss (e.g., how well the 3D assistive logo 112 aids in detection). In the example of FIG. 1, the detector algorithm 124 may be implemented by one or more of a you only look once (YOLO) algorithm (e.g., YOLOv2, YOLOv3, etc.) or a CNN (e.g., a region-based CNN (R-CNN), a mask R-CNN, etc.), among others. For example, a CNN implementation of the detector algorithm 124 has a MobileNet architecture or a SqueezeDet architecture.

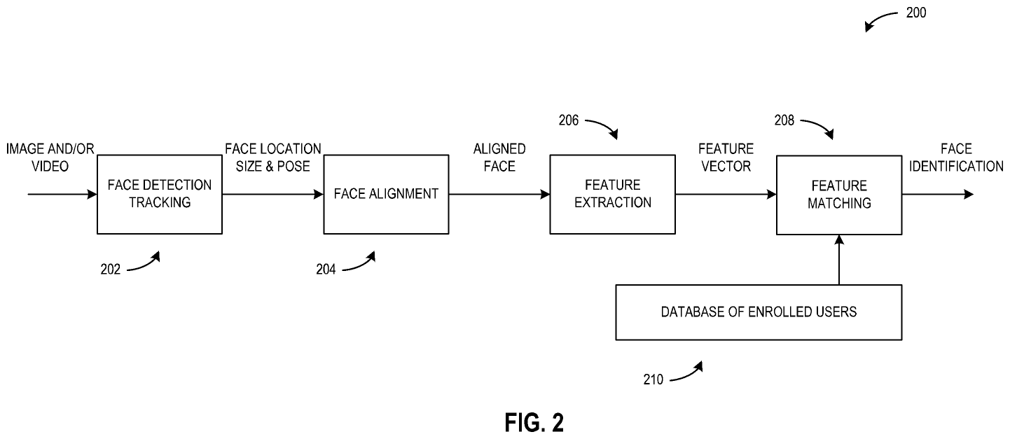

FIG. 2 is a block diagram of an example processing flow 200 of an algorithm for facial recognition. In the example of FIG. 2, the processing flow 200 includes an example face detection tracking stage 202 in which the algorithm is executed to detect the location, size, and pose of a face in an image and/or a video. In an example face alignment stage 204 of the processing flow 200, the algorithm is executed to digitally adjust the image and/or the video to a standardized position, correcting for variations in pose, rotation, and facial expression.

In the illustrated example of FIG. 2, the processing flow 200 includes an example feature extraction stage 206 in which the algorithm is executed to generate a feature vector including features of the detected face such as the shape, size, and relative position of facial components like the eyes, nose, mouth, eyebrows, and chin. In the example of FIG. 2, in an example feature matching stage 208 of the processing flow 200, the algorithm is executed to compare the feature vector against one or more feature vectors stored in an example database 210 of enrolled users. For example, execution of the algorithm compares the feature vectors to determine if the feature vector of the detected face matches one or more feature vectors of one or more enrolled users. Assuming the algorithm detects a match, the algorithm outputs an identification of the face.

As described above in FIGS. 1 and 2, algorithms that perform different tasks on data have different processing flows. In addition to differences in processing flows for algorithms that perform different tasks, data processing data is also complicated by the fact than an individual algorithm can be implemented differently depending on the hardware utilized to execute and/or instantiate the algorithm. That is, the code to implement an algorithm (e.g., a given AI/ML model having a given architecture) may vary depending on the hardware (e.g., a CPU, a chiplet, an array of chiplets, a GPU, an FPGA, etc.) on which the algorithm is to be executed and/or instantiated. For example, code to implement an algorithm on a CPU is designed to process data sequentially whereas code to implement the algorithm on a GPU is designed to execute many threads simultaneously to support parallel processing. Additionally, code to implement the algorithm on an FPGA is designed to instantiate a hardware implementation of the algorithm on the FPGA.

Data processing data is further complicated by the fact that, in some examples, the same data type (e.g., matrix data) may result in different performance characteristics for a given algorithm depending on the nature of the data, the implementation of the algorithm, and the programmable circuit used to implement the algorithm. For example, in case of a neural network that is used to detect objects in an image, the efficiency of the algorithm may depend on the sparsity of the raw data, the implementation of the algorithm, and the actual hardware used to execute the neural network.

As a result of at least the above-described complications of data processing, selecting an implementation (e.g., the best, optimal, most efficient, most performant, etc. implementation) of an algorithm to process given data is a complicated task. For example, selecting the most performant implementation of an algorithm depends on at least the characteristics of the data to be processed and available programmable circuit(s) at a given point in time. Some approaches to this task utilize static techniques. For example, a systolic array is a homogenous network of tightly coupled data processing units (DPUs) that are very efficient for processing sparse matrices.

However, static techniques process all data types similarly without considering characteristics of data to be processed, availability of one or more programmable circuits that are better suited to process the type of data, and which programmable circuit will satisfy a service level objective (SLO) for the type of data and/or software that requested processing of the data. For example, at a given point of time, an application (e.g., software) may favor performance per watt (PPW) or power consumption with certain latency constraints rather than the most performant option for processing data. As such, static techniques cannot dynamically and adaptively select an implementation of an algorithm (e.g., for a given data type). Additionally, hardware-based techniques to select an implementation of an algorithm to process given data are ineffective. For example, hardware-based techniques do not consider on-the fly characterization of the data, tagging of data objects, and/or subsequent usage of such tags (e.g., metadata) to perform dynamic load balancing to select the one or more programmable circuits and one or more implementations of an algorithm to be executed and/or instantiated by the one or more programmable circuits.

The following introduces examples of computer hardware for data processing operations, applicable in programmable architectures such as chiplet-based processors, System-on-chip (SoC) circuitry, System-in-Package (SiP) or System-on-Package (SoP) circuitry, and/or any other modular packaging implementations of programmable circuitry. The following hardware examples specifically provide methods, apparatus, and articles of manufacture to schedule algorithms based on characteristics of data. Disclosed methods, apparatus, and articles of manufactures include data plane circuitry that routes and injects data objects into a compute device. For example, the compute device may be a server, a SiP, a SoC, or a SoP, among others. Also for example, the data plane circuitry may be network interface circuitry (e.g., a chiplet, a tile, a card, etc.) of the compute device, a Compute Express Link (CXL)-compatible card of the compute device, or an I/O hub (e.g., a chiplet and/or a tile responsible for routing I/O communications between chiplets and/or tiles) of the compute device, among others.

Examples disclosed herein also include programmable circuitry that processes data objects. For example, the programmable circuitry is implemented by one or more programmable circuits of the compute device such as a processor core, a chiplet, or an accelerator, among others. In examples disclosed herein, example programmable circuitry includes an interface (e.g., an application programming interface (API) based on an instruction in an instruction set architecture (ISA) of the programmable circuitry) to communicate with example load balancer circuitry of the compute device to broker processing of one or more data objects. For example, the programmable circuitry can specify a service level objective (SLO) and/or a service level agreement (SLA) for a data object and request scheduling of an algorithm to process the data object.

Based on the SLO and/or SLA of the data object, a data type and/or other characteristic of the data object, available implementations of the algorithm, and/or available processing capacity at the compute device, example load balancer circuitry disclosed herein dynamically selects the implementation of the algorithm to process the data object. For example, as data objects are generated and/or streamed into storage (e.g., memory, CXL memory, cache, etc.), example data plane circuitry disclosed herein analyzes the data objects on-the-fly before the data objects are processed by performance of one or more algorithms on hardware. As such, example data plane circuitry can determine the nature of the data objects (e.g., respective characteristics of the data objects) and generate metadata that can be used by example load balancer circuitry to select how to most efficiently process the data objects (e.g., to satisfy respective SLOs and/or SLAs of the data objects).

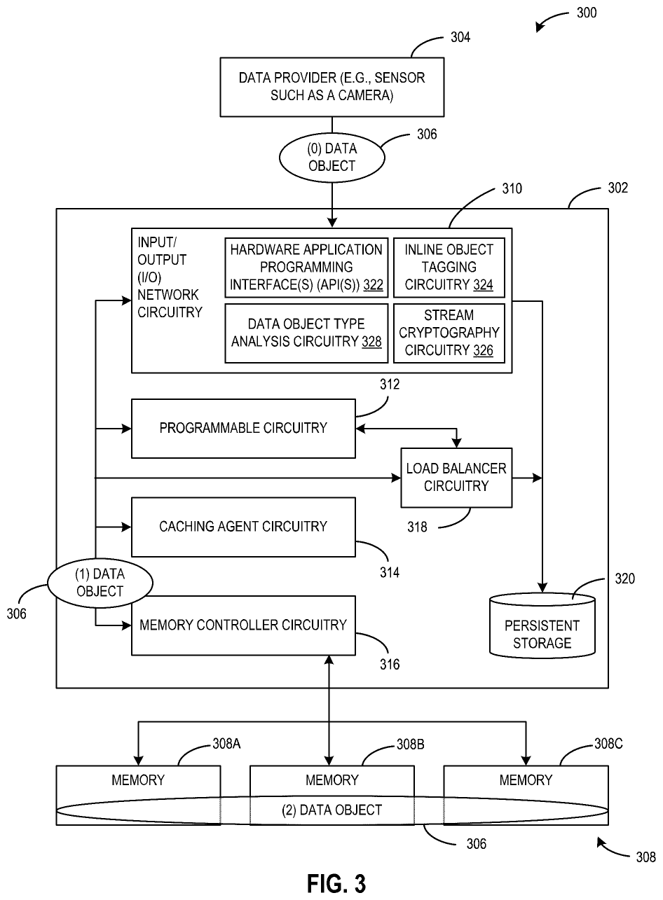

FIG. 3 is a block diagram of an example system 300 including an example compute device 302 in communication with an example data provider 304 to receive and analyze an example data object 306 to improve processing of the data object 306 at the compute device 302. In the example of FIG. 3, the compute device 302 analyzes the data object 306 to determine at least one characteristic of the data object 306 as or after (e.g., shortly after) the data object 306 is ingested into the compute device 302. For example, the compute device 302 augments metadata of the data object 306 to indicate at least one characteristic of the data object 306. As such, the metadata of the data object 306 can inform how the compute device 302 processes the data object 306.

In examples disclosed herein, a “data object” refers to a structured unit of data that holds a collection of related values representing a real-world entity such as an image, a person, a product, or an event. Each value of a data object may be identified by a specific name or attribute, allowing for organized access and manipulation of information within a compute device. Example data objects include image data objects, person data objects, product data objects, event data objects, and telecommunications data objects (e.g., text message data objects, phone call data objects, video call data objects, etc.), among others.

In examples disclosed herein, “metadata” refers data providing information about one or more aspects of a data object. Example metadata of a data object includes fields identifying characteristics of a data object, a payload type of the data object, and information associated with how the data object was generated (e.g., for an image, the standard used to compress the image). Example data of a person data object includes estimated age, sex (e.g., male or female), and height, among others and example metadata of the person data object includes information about estimation of the data (e.g., algorithm utilized to estimate), when the data was estimated, and likelihood of accuracy of the data (e.g., percentage confidence in the estimated value), among others.

In examples disclosed herein, a “characteristic” refers to a trait, quality, or property of a data object. Examples of characteristics with which the metadata may be augmented include a data type of the data object 306 and a level of sparsity of the data object 306. For example, based on analysis performed by the compute device 302, the compute device 302 augments metadata of the data object 306 to identify whether the data object 306 is an image data object, a person data object, etc. and/or the level of sparsity of the data object 306. Example characteristics may vary depending on the type of the data object 306. For example, if the data object 306 is an image, examples of additional or alternative characteristics with which the metadata may be augmented include characteristics of the image such as brightness, dimensions (e.g., the width and height of an image in pixels, such as 1920×1080), resolution (e.g., the level of detail in an image, often represented as dots per inch (DPI) or pixels per inch (PPI)), format (e.g., the file format of an image such as a Joint Photographic Experts Group (JPEG) format, a portable network graphic (PNG) format, a tag image file format (TIFF), etc. which can affect the quality and compression of the image), number of channels, and quality, among others.

Also, for example, if the data object 306 is an image, examples of characteristics with which the metadata may be augmented include image type (e.g., an image related to X-rays in a hospital, an image related to surveillance, etc.). Other characteristics with which the metadata may be augmented for an image include what the image depicts, a number of objects in the image, a type of person depicted in the image, or a type of car depicted in the image, among others. For example, if the data object 306 is an image that depicts a group of people, examples of characteristics with which the metadata may be augmented include estimated ages of individual people in the image, an estimated number of men and women in the image, and estimated heights of individual people in the image, among others.

Additionally, if the data object 306 is an image, examples of characteristics with which the metadata may be augmented include camera and/or device information, exposure settings, color profile, and watermarking information. For example, camera and/or device information includes information about the camera or device used to capture an image, such as make and model. Exposure settings include camera settings when an image was taken, including sensitivity to light, shutter speed, and aperture settings. A color profile includes information about the color settings used in an image, which can affect how the image is displayed on different devices. Watermarking information specifies whether an image includes a digital watermark and other information about the digital watermark (e.g., how the digital watermark was embedded, how the digital watermark can be detected, etc.). A watermark (e.g., a company logo embedded in an image) can serve as a security measure to assert copyright or attribute ownership.

If, for example, the data object 306 is a person data object, examples of additional or alternative characteristics with which the metadata of the person data object may be augmented include characteristics of estimated data such as an algorithm used to estimate the data, when the data was estimated, and a likelihood of accuracy of the data, among others. In general, a characteristic with which metadata of a data object may be augmented includes any trait, quality, or property of the data object that provides context regarding whether the data object should be further processed. General examples of characteristics with which metadata of a data object may be augmented include file size (e.g., the size of the data object, usually measured in bytes (e.g., kilobytes (KB), megabytes (MB), etc.), which for certain data object types such as images, can indicate the resolution and quality of an image), date created (e.g., the date and time the data object was created), date modified (e.g., the most recent date and time when the data object was modified), and geolocation data (e.g., global positioning system (GPS) coordinates indicating the location where data for the data object was collected such as where an image was captured, where a person corresponding to a person data object was detected, etc.).

Additionally, general examples of characteristics with which metadata of a data object may be augmented include access control lists (ACLs), encryption status, and checksum or hash values. For example, an ACL is a list defining who can access or modify a data object (e.g., an ACL may restrict who can access a data object to certain user groups or individuals). Encryption status indicates whether a data object is encrypted. For example, a data object may be stored in an encrypted.enc format to protect the content of the data object from unauthorized access. A checksum or hash value is a unique value generated from the content of a data object (e.g., a 256-bit secure hash algorithm (SHA) (e.g., a SHA-256) hash), which can be used to verify the integrity of the data object and detect any unauthorized modifications to the data object.

In some examples, general examples of characteristics with which metadata of a data object may be augmented include digital signature information, file permission information, and audit trail information. For example, digital signature information indicates whether a data object has been digitally signed, which provides proof that the data object has not been altered and is from a verified source. File permission information denotes the permissions assigned to a data object, such as read, write, or execute access for different users (e.g., a data object may have read-only permissions for general users and editing permissions for administrators). An audit trail is a record of actions taken on a data object, such as views, downloads, or edits. Audit trails can help identify unauthorized access or changes to a data object.

General examples of characteristics with which metadata of a data object may be augmented also include ownership information, environmental context, and data loss prevention (DLP) tags. For example, ownership information includes details about the owner of a data object, which may include a user account that created or uploaded the data object. Ownership information can be important for accountability. Environmental context information includes data related to what security measures were in place when a data object was created or accessed, such as whether the creation or access was done over a secured connection such as hypertext transfer protocol secure (HTTPS). A DLP tag is a label or tag applied to a data object to identify that the data object includes sensitive information and should be treated with additional security precautions.

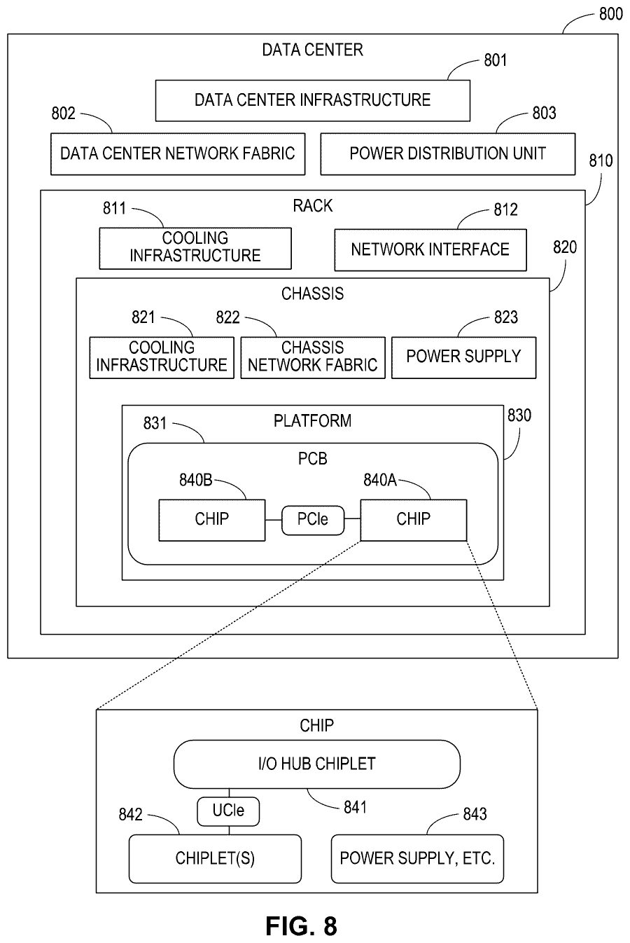

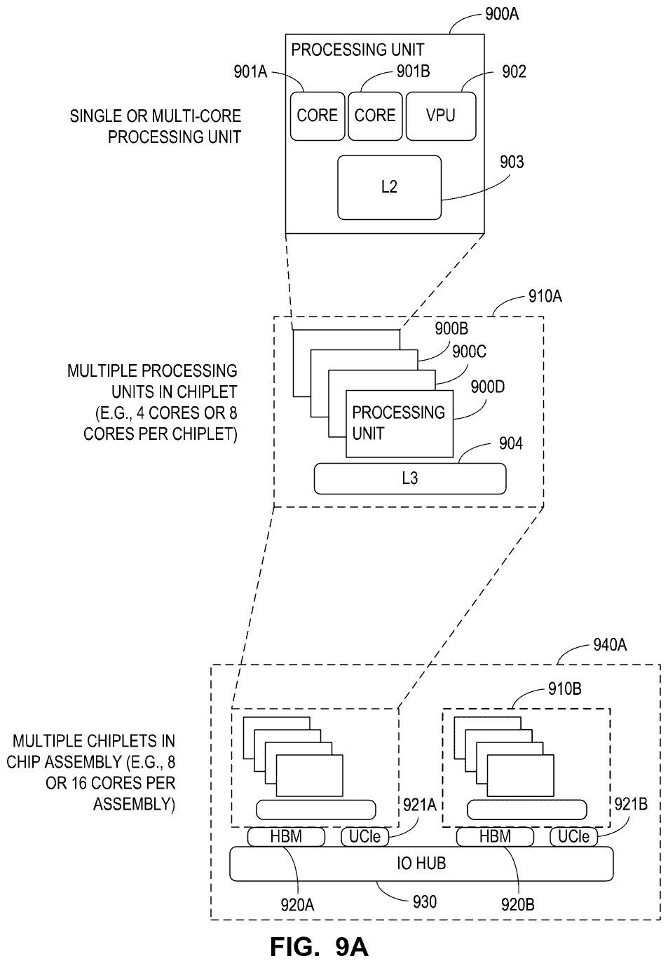

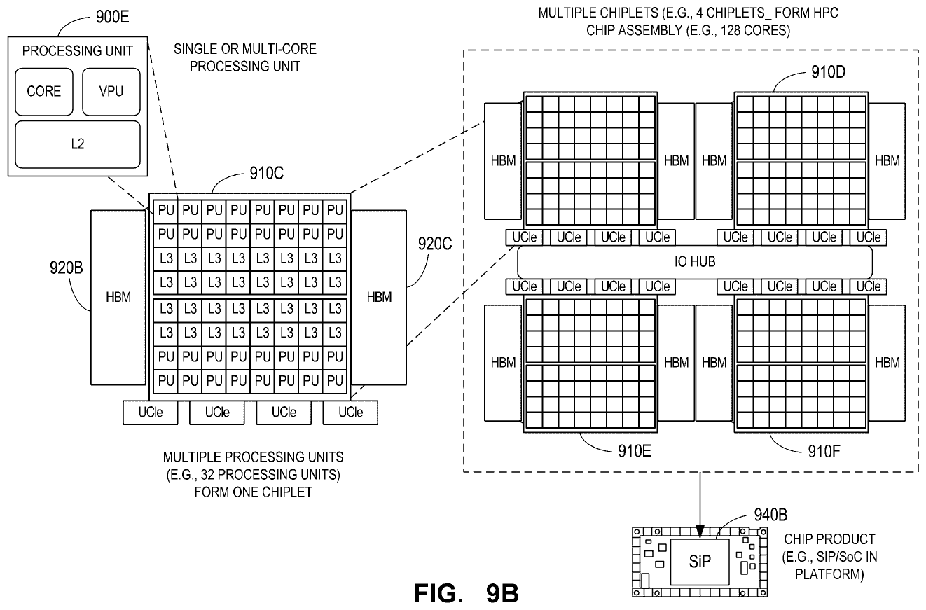

In the illustrated example of FIG. 3, the compute device 302 is implemented by a programmable architecture such as one or more microprocessors, GPUs, FPGAs, chiplet-based processors, SoC circuitry, SiP or SoP circuitry, and/or any other modular packaging implementation of programmable circuitry. As used herein, a chiplet refers to any integrated circuit (IC) that has a modular structure designed to have one or more specified functionalities and to be combinable with other chiplets on an interposer or other substrate in a package. Examples of chiplets are compute chiplets that include programmable circuitry (e.g., one or more programmable circuits, such as one or more cores, etc.) and supporting circuitry (e.g., local memory, etc.) to provide functionality (e.g., to execute a host operating system (OS), applications, etc.), memory chiplets that include memory accessible to one or more other chiplets, communication chiplets that include communication interfaces (e.g., input/output hubs, networks, etc.) to enable other chiplets to communicate with each other and/or to other devices external to the package, etc. Example multi-tier management architectures provide a flexible management architecture that is multi-tiered to enable management of chiplet-based compute devices that include various combinations of chiplets from various manufacturers. Example chiplets are further described below in conjunction with FIGS. 8, 9A, and 9B.

As used herein, a tile refers to any IC that has a modular structure designed to have one or more specified functionalities and to be combinable with other tiles in a chiplet. For example, a chiplet includes multiple tiles that are connected via a network-on-chip (NoC). As described herein, two or more chiplets are connected via interconnect constructs (e.g., chiplets for connectivity). Chiplets may be manufactured separately and assembled post-manufacturing. In examples disclosed herein, tiles can group one or more circuits into a single tile to implement a specified feature and/or group of features. Furthermore, tiles from different manufacturers can be combined into a given chiplet, and/or tiles can be replicated for inclusion in a given chiplet. Examples of tiles are compute tiles that include one or more programmable circuits (e.g., cores) and supporting circuitry (e.g., local memory) to provide functionality (e.g., to execute a host OS, applications, etc.) in a chiplet, memory tiles that include memory accessible to one or more other tiles in the chiplet, memory controller tiles to control access to the memory tiles in the chiplets, etc. In some examples, individual tiles and/or individual chiplets are implemented on separate dies (e.g., semiconductor dies) from other tiles and/or chiplets. Additionally or alternatively, two or more tiles and/or two or more chiplets are implemented on a common die.

In the illustrated example of FIG. 3, the compute device 302 includes example input/output (I/O) network circuitry 310, example programmable circuitry 312, example caching agent circuitry 314, example memory controller circuitry 316, example load balancer circuitry 318, and example persistent storage 320. In the example of FIG. 3, the I/O network circuitry 310 is in communication with the data provider 304, the programmable circuitry 312, the caching agent circuitry 314, the memory controller circuitry 316, the load balancer circuitry 318, and the persistent storage 320. In the example of FIG. 3, the I/O network circuitry 310 may be instantiated (e.g., creating an instance of, bring into being for any length of time, materialize, implement, etc.) by programmable circuitry. For example, programmable circuitry may be implemented by a CPU executing first instructions, an FPGA, a programmable logic device (PLD), a generic array logic (GAL) device, a programmable array logic (PAL) device, a complex programmable logic device (CPLD), a simple programmable logic device (SPLD), a microcontroller unit (MCU), a programmable system on chip (PSoC), etc.

Additionally or alternatively, the I/O network circuitry 310 may be instantiated (e.g., creating an instance of, bring into being for any length of time, materialize, implement, etc.) by (i) an Application Specific Integrated Circuit (ASIC) and/or (ii) a FPGA (e.g., another form of programmable circuitry) structured and/or configured in response to execution of second instructions to perform operations corresponding to the first instructions. It should be understood that some or all of the circuitry of the I/O network circuitry 310 may, thus, be instantiated at the same or different times. Some or all of the circuitry of the I/O network circuitry 310 may be instantiated, for example, in one or more threads executing concurrently on hardware and/or in series on hardware. Moreover, in some examples, some or all of the circuitry of the I/O network circuitry 310 may be implemented by one or more chiplets, tiles, and/or microprocessor circuitry executing instructions and/or by one or more FPGAS performing operations to implement one or more virtual machines and/or containers.

In the illustrated example of FIG. 3, the I/O network circuitry 310 is implemented by hardware (e.g., a chiplet, one or more tiles, a core, an FPGA, etc.), software, and/or firmware. For example, the I/O network circuitry 310 is implemented in accordance with any type of interface standard. Example interface standards include a Peripheral Component Interconnect (PCI) interface, a Peripheral Component Interconnect Express (PCIe) interface, and/or a Compute Express Link (CXL) interface such as the CXL interface for cache-coherent accesses to system memory (CXL.cache or CXL.$), the CXL interface for device memory (CXL.Mem), or the CXL interface for PCIe-based I/O devices (CXL.IO/PCIe). Additionally or alternatively, the I/O network circuitry 310 is implemented in accordance with an Ethernet interface, a universal serial bus (USB) interface, a Bluetooth® interface, and/or a near field communication (NFC) interface. In some examples, the I/O network circuitry 310 is implemented in accordance with a die-to-die interconnect such as an embedded multi-die interconnect bridge (EMIB), a co-EMIB, a high bandwidth memory (HBM) interconnect, a chip-on-wafer-on-substrate (CoWoS) interconnect, an integrated fan-out (InFO) interconnect, and/or an organic substrate-based interconnect.

In the illustrated example of FIG. 3, the I/O network circuitry 310 includes at least one example hardware application programming interface (API) 322, example inline object tagging circuitry 324, example stream cryptography circuitry 326, and example data object type analysis circuitry 328. One or more of the at least one example hardware API 322, the inline object tagging circuitry 324, the stream cryptography circuitry 326, or the data object type analysis circuitry 328 is implemented by one or more cores of a microprocessor, one or more FPGAs, one or more chiplets, and/or one or more tiles. As described herein, the at least one hardware API 322 can be accessed by the data provider 304 to register a stream of data with the I/O network circuitry 310.

For example, when the data provider 304 connects to the compute device 302 via the I/O network circuitry 310, the data provider 304 can register a data stream with the I/O network circuitry 310. Example registration includes the data provider 304 providing information specifying how the I/O network circuitry 310 can identify respective starts and ends of data objects communicated via the data stream. For example, the data provider 304 may provide a data object across multiple network payloads or packets. In some examples, example registration also includes the data provider 304 providing a cryptographic key (e.g., a private key) with which the data stream is decryptable. In some examples, the cryptographic key is generated by another entity (e.g., the stream cryptography circuitry 326, a third-party key manager, etc.). Based on registration of a data stream, the I/O network circuitry 310 causes storage of (1) the information indicative of respective starts and ends of data objects of the data stream and (2) the cryptographic key with which the data stream is decryptable in the persistent storage 320.

Additionally or alternatively, example registration includes the data provider 304 specifying an access control list for a data object and/or an access control list for a data stream. In the example of FIG. 3, the access control list specifies one or more data consumers that are permitted to access the data object 306 and the extent to which the one or more data consumers can access the data object 306 (e.g., all of the raw data, associated metadata, etc.). In this manner, the data provider 304 can control whether metadata generated by the I/O network circuitry 310 is public to any entity associated with the compute device 302 or if the metadata is accessible to only a subset of entities. For example, the access control list may specify that only software having an identity (e.g., a universally unique identifier (UUID)) present in the access control list can access the data object 306. In some examples, based on registration of a data stream, the I/O network circuitry 310 causes storage of the access control list in the persistent storage 320.

In the illustrated example of FIG. 3, the at least one hardware API 322 can be implemented in multiple manners. For example, the at least one hardware API 322 is implemented as a dedicated and/or predefined port through which the data provider 304 can register a data stream with the I/O network circuitry 310. Additionally or alternatively, the at least one hardware API 322 is implemented as an intelligent platform management interface (IPMI) through which a baseboard management controller (BMC) of the compute device 302 advertises the internet protocol (IP) address and/or port address of the I/O network circuitry 310. In some examples, the at least one hardware API 322 is implemented by a representational state transfer (REST) interface implemented in accordance with the Redfish standard. Based on the IP and/or port address of the I/O network circuitry 310, the data provider 304 can register a data stream with the I/O network circuitry 310.

In some examples, the at least one hardware API 322 is implemented by a single multi-function API. Additionally or alternatively, the at least one hardware API 322 is implemented by multiple APIs where each of the APIs has relatively less functionality compared to a single multi-function API. In an example where the at least one hardware API 322 is implemented by multiple APIs, a first API allows the data provider 304 (e.g., a sensor) to provide information indicative of respective starts and ends of data objects of the data stream. Additionally, in an example where the at least one hardware API 322 is implemented by multiple APIs, a second API can be accessed by the data provider 304 to provide the cryptographic key with which the data stream is decryptable.

In the illustrated example of FIG. 3, the inline object tagging circuitry 324 analyzes data that is transferred into the compute device 302 via the I/O network circuitry 310 (e.g., in this example, the inline object tagging circuitry 324 analyzes data inline and on-the-fly). In the example of FIG. 3, the inline object tagging circuitry 324 analyzes bytes of a data stream communicated to the I/O network circuitry 310 to identify the start and end of the data object 306 (e.g., that is part of the data stream). For example, the inline object tagging circuitry 324 identifies the start and end of the data object 306 based on embedded information within payloads (e.g., network payloads) of data packets of the data stream and stored in the persistent storage 320 during registration of the data stream with the I/O network circuitry 310.

In some examples, the inline object tagging circuitry 324 provides data packets of a data stream to the stream cryptography circuitry 326 to decrypt the data packets using the cryptographic key stored in the persistent storage 320 during registration of the data stream with the I/O network circuitry 310. For example, the stream cryptography circuitry 326 is configured to operate in accordance with one or more cryptographic standards and/or protocols. Example cryptographic standards and/or protocols include a transport layer security (TLS) protocol, an Advanced Encryption Standard (AES), a secure sockets layer (SSL) protocol, a National Institute of Standards and Technology (NIST) standard, and an Internet Engineering Task Force (IETF) standard.

In the illustrated example of FIG. 3, after identifying the data object 306 in a data stream, the inline object tagging circuitry 324 determines at least one tag to apply to the data object 306. For example, the inline object tagging circuitry 324 applies a tag to the data object 306 by adjusting metadata of the data object 306. In the example of FIG. 3, the data object 306 includes information (e.g., provided by the source of the data object 306) that may inform how the data object type analysis circuitry 328 is to pre-process the data object 306 to determine at least one characteristic of the data object 306. For example, based on the information included in the data object 306, the inline object tagging circuitry 324 may tag the data object 306 to identify a payload type of the data object 306 (e.g., a color image, an X-ray image, a phone call, etc.).

Additionally or alternatively, based on the information included in the data object 306, the inline object tagging circuitry 324 may tag the data object 306 to identify other information such as, for an image, how the image was generated (e.g., a standard used to compress the image). In the example of FIG. 3, based on identifying and tagging the data object 306, the inline object tagging circuitry 324 provides a pointer to the data object type analysis circuitry 328. As described above, the data provider 304 may provide a data object across multiple network payloads or packets. In the example of FIG. 3, once the inline object tagging circuitry 324 detects the end of the data object 306 in the data stream and tags the data object 306, the inline object tagging circuitry 324 provides a pointer to the start of the data object 306 in the memory 308.

In the illustrated example of FIG. 3, based on the pointer, the data object type analysis circuitry 328 access the data object 306. In the example of FIG. 3, the data object type analysis circuitry 328 analyzes the data object 306 based on at least one tag applied to the data object 306 by the inline object tagging circuitry 324. Based on analysis of the data object 306, the data object type analysis circuitry 328 determines at least one characteristic (e.g., a level of sparsity) of the data object 306. For example, if the data object 306 is an image, the data object type analysis circuitry 328 determines a level of sparsity of the data object 306. To determine a level of sparsity of the data object 306, the data object type analysis circuitry 328 processes the bits of the data object 306 inline to determine the number of zero bits and the number of non-zero bits. Based on the number of zero bits and the number of non-zero bits, the data object type analysis circuitry 328 determines the level of sparsity of the data object 306.

In the illustrated example of FIG. 3, based on the at least one characteristic of the data object 306 (e.g., as determined by the data object type analysis circuitry 328), the inline object tagging circuitry 324 adjusts metadata associated with the data object 306. For example, the inline object tagging circuitry 324 updates a field in metadata associated with the data object 306 to indicate that the data object 306 has the at least one characteristic. Additionally, the inline object tagging circuitry 324 causes storage of at least the metadata (e.g., in the memory 308). In some examples, the inline object tagging circuitry 324 causes storage of the metadata in the caching agent circuitry 314.

In the illustrated example of FIG. 3, the programmable circuitry 312 is in communication with the I/O network circuitry 310, the caching agent circuitry 314, the memory controller circuitry 316, and the load balancer circuitry 318. In the example of FIG. 3, the programmable circuitry 312 is implemented by one or more programmable circuits (e.g., processor cores, accelerator circuits, FPGAs, chiplets, etc.) of a compute device. For example, in a 68-core processor, the programmable circuitry 312 is implemented by 64 cores of the processor. In some examples, the programmable circuitry 312 is implemented by one or more chiplets and/or one or more tiles either alone or in combination with other programmable circuitry.

In the illustrated example of FIG. 3, the caching agent circuitry 314 is in communication with the I/O network circuitry 310, the programmable circuitry 312, the memory controller circuitry 316, and the load balancer circuitry 318. In the example of FIG. 3, the caching agent circuitry 314 is implemented by one or more chiplets and/or one or more tiles either alone or in combination with other programmable circuitry. Additionally, in the example of FIG. 3, the caching agent circuitry 314 manages cached data and/or metadata. For example, the caching agent circuitry 314 includes a cache to store data and/or metadata and the caching agent circuitry 314 manages one or more data objects represented by the data and/or the metadata.

In the illustrated example of FIG. 3, the memory controller circuitry 316 is in communication with the I/O network circuitry 310, the programmable circuitry 312, the caching agent circuitry 314, and the load balancer circuitry 318. The memory 308 of this example is a bank of memory which includes multiple instances of memory to support a multi-channel interface between the memory bank 308 and the compute device 302. In the example of FIG. 3, the memory bank 308 includes a first example memory 308A, a second example memory 308B, and a third example memory 308C. In the example of FIG. 3, the memory controller circuitry 316 is in communication with the first memory 308A, the second memory 308B, and the third memory 308C.

In the illustrated example of FIG. 3, the memory controller circuitry 316 is implemented by hardware (e.g., a chiplet, one or more tiles, etc.) in accordance with any type of memory interface standard, such as a Joint Electron Device Engineering Council (JEDEC) standard. Example JEDEC standards include double data rate (DDR) standards such as DDR, DDR2, DDR3, DDR4, DDR5, and DDR6. Additional or alternative DDR standards include mobile DDR (MDDR) standards such as low power DDR (LPDDR), LPDDR2, LPDDR3, LPDDR4, LPDDR5,LPDDR6, etc. DDR standards also include graphics DDR (GDDR) standards such as GDDR, GDDR2, GDDR3, GDDR4, GDDR5, and GDDR6. In some examples, the memory interface standard is a RAMBUS® standard such as extreme data rate (XDR) or XDR2.

In the illustrated example of FIG. 3, the memory controller circuitry 316 accesses the memory 308 based on a request from the I/O network circuitry 310, the programmable circuitry 312, the load balancer circuitry 318, and/or another entity. For example, a request includes an identifier (e.g., a UUID) of a data object. Based on a request, the memory controller circuitry 316 accesses an identifier (e.g., a UUID) of the entity that generated the request. In some examples, the memory controller circuitry 316 accesses a certificate for the entity where the certificate includes the identifier (e.g., a UUID) of the entity. Additionally, based on the request, the memory controller circuitry 316 cross-references the identifier of the entity with the access control list for the data object identified in the request. In this manner, the memory controller circuitry 316 determines whether to grant or deny access to a data object identified in a request.

In the illustrated example of FIG. 3, the load balancer circuitry 318 is in communication with the I/O network circuitry 310, the programmable circuitry 312, the caching agent circuitry 314, the memory controller circuitry 316, and the persistent storage 320. In the example of FIG. 3, the load balancer circuitry 318 is implemented by hardware (e.g., a chiplet, one or more tiles, etc.). For example, the load balancer circuitry 318 may be instantiated (e.g., creating an instance of, bring into being for any length of time, materialize, implement, etc.) by programmable circuitry. For example, programmable circuitry may be implemented by a CPU executing first instructions, an FPGA, a PLD, a GAL device, a PAL device, a CPLD, a SPLD, an MCU, a PSoC, etc.

Additionally or alternatively, the load balancer circuitry 318 may be instantiated (e.g., creating an instance of, bring into being for any length of time, materialize, implement, etc.) by (i) an ASIC and/or (ii) a FPGA (e.g., another form of programmable circuitry) structured and/or configured in response to execution of second instructions to perform operations corresponding to the first instructions. It should be understood that some or all of the circuitry of the load balancer circuitry 318 may, thus, be instantiated at the same or different times. Some or all of the circuitry of the load balancer circuitry 318 may be instantiated, for example, in one or more threads executing concurrently on hardware and/or in series on hardware. Moreover, in some examples, some or all of the circuitry of the load balancer circuitry 318 may be implemented by microprocessor circuitry executing instructions and/or FPGA circuitry performing operations to implement one or more virtual machines and/or containers.

In the illustrated example of FIG. 3, the load balancer circuitry 318 is implemented by one or more processor cores of a compute device. For example, in a 68-core processor, the load balancer circuitry 318 is implemented by four cores of the processor. In some examples, the load balancer circuitry 318 is implemented by one or more chiplets and/or one or more tiles either alone or in combination with other programmable circuitry. In the example of FIG. 3, the load balancer circuitry 318 provides a separate compute domain that is not visible to and/or is not usable by the software running on the programmable circuitry 312. For example, isolation of the load balancer circuitry 318 facilitates security and efficiency of the load balancer circuitry 318.

In the illustrated example of FIG. 3, the load balancer circuitry 318 is an embedded microcontroller running an OS that provides a variety of features and services described herein. In some examples, the OS of the load balancer circuitry 318 is adjusted (e.g., to adjust operation of the load balancer circuitry 318) and/or updated. In the example of FIG. 3, the OS of the load balancer circuitry 318 allows the programmable circuitry 312 to request scheduling of an algorithm on at least one programmable circuit of the programmable circuitry 312 to process the data object 306. For example, the load balancer circuitry 318 manages execution of the algorithm on at least one programmable circuit based on a given SLO and/or SLA for the data object 306.

In the illustrated example of FIG. 3, the load balancer circuitry 318 schedules the algorithm to process the data object 306 on at least one programmable circuit based on the SLO and/or SLA of the data object 306, metadata of the data object 306 (e.g., a data type and/or other characteristic of the data object 306), an algorithm mapping table stored in the persistent storage 320, and available processing capacity at the compute device 302. For example, the algorithm mapping table stored in the persistent storage 320 maps an algorithm (e.g., maps machine-readable instructions) to respective types of programmable circuits capable of performing the algorithm and at least one key performance indicator (KPI) for the respective types of programmable circuits. For example, a KPI for a type of programmable circuit is a target processing time for the programmable circuit or a target bandwidth for the programmable circuit. Additional or alternative KPIs for a type of programmable circuit include a number of frames per second achieved by the programmable circuit, tera-operations per second performed by the programmable circuit at a given precision (e.g., 8-bit integer precision), performance per watt of the programmable circuit, or processing latency for the programmable circuit to process a data object, among others. In the example of FIG. 3, the SLO and/or the SLA for the data object 306 is provided by a software stack executed by the programmable circuitry 312 as described herein.

In the illustrated example of FIG. 3, the persistent storage 320 stores information indicative of respective starts and ends of data objects of a data stream, a cryptographic key with which a data stream is decryptable, and the algorithm mapping table. In the example of FIG. 3, the persistent storage 320 is implemented by non-volatile memory such as a read-only memory (ROM), a programmable ROM (PROM), an erasable PROM (EPROM), an electrically erasable PROM (EEPROM), ferroelectric random-access memory (RAM), and/or flash memory, among others. While in the illustrated example the persistent storage 320 is illustrated as a single storage, the persistent storage 320 may be implemented by any number and/or type(s) of storages. For example, one instance of the persistent storage 320 may be associated with and/or for exclusive storage of data by the I/O network circuitry 310 and another instance of the persistent storage 320 may be associated with and/or for exclusive storage of data by the load balancer circuitry 318. Data stored in the persistent storage 320 may be in any data format such as, for example, binary data, comma delimited data, tab delimited data, structured query language (SQL) structures, etc.

In the illustrated example of FIG. 3, the data provider 304 is an entity that generates data to be analyzed by the I/O network circuitry 310 as described herein. For example, the data provider 304 is a sensor such as an X-ray machine. In some examples, the data provider 304 can be implemented by any other type of sensor such as a pressure sensor (e.g., a blood pressure sensor), a biochemical sensor (e.g., a glucose monitor, a pulse oximeter, a pregnancy test, etc.), an image sensor (e.g., an X-ray machine, an ultrasound machine, a magnetic resonance imaging (MRI) machine, a positron emission tomography (PET) scanner, etc.), a temperature sensor (e.g., a thermometer), and a respiration rate sensor, among others.

In additional or alternative examples, the data provider 304 is implemented by an accelerometer, a light sensor, a sound sensor, a pressure sensor, a camera, a thermal sensor, an electrical field sensor, a chemical sensor, an infrared sensor, or a seismic sensor, among others. In some examples, the data provider 304 is an entity internal to the compute device 302. In such examples, the data provider 304 may be the programmable circuitry 312 as described herein.

In the illustrated example of FIG. 3, the memory 308 includes the first memory 308A, the second memory 308B, and the third memory 308C. For example, one or more of the first memory 308A, the second memory 308B, or the third memory 308C is implemented by a volatile memory (e.g., a Synchronous Dynamic Random Access Memory (SDRAM), Dynamic Random Access Memory (DRAM), RAMBUS® Dynamic Random Access Memory (RDRAM), etc.) and/or a non-volatile memory (e.g., flash memory). One or more of the first memory 308A, the second memory 308B, or the third memory 308C may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the memory 308 is illustrated as a multiple memories, the memory 308 may be implemented by a single memory. In additional or alternative examples, the memory 308 may be implemented by any number and/or type(s) of memories. Furthermore, the data stored in the memory 308 may be in any data format such as, for example, binary data, comma delimited data, tab delimited data, SQL structures, etc.

In the illustrated example of FIG. 3, the first memory 308A, the second memory 308B, and the third memory 308C are implemented externally to the compute device 302. In some examples, one or more of the first memory 308A, the second memory 308B, or the third memory 308C is implemented internal to the compute device 302 (e.g., as one or more chiplets and/or one or more tiles). In the example of FIG. 3, the first memory 308A, the second memory 308B, and the third memory 308C are implemented in accordance with a memory interface standard such as a JEDEC standard (e.g., a DDR standard, an mDDR standard, a GDDR standard, etc.) and/or a RAMBUS® standard (e.g., an XDR standard). Additionally, the first memory 308A, the second memory 308B, and the third memory 308C are implemented in accordance with a memory form factor such as the dual in-line memory module (DIMM) form factor. Other memory form factors are possible such as the universal DIMM (UniDIMM) form factor, the Accelerated Graphics Port (AGP) in-line memory module (AIMM) form factor, the compression attached memory module (CAMM) form factor, the single in-line memory module (SIMM) form factor, and/or the single in-line pin package (SIPP) form factor.

As described herein, the multiple instances of the memory 308 support a multi-channel interface between the memory 308 and the compute device 302. For example, a memory channel refers to a communication path between the memory 308 and the compute device 302. In the example of FIG. 3, the memory 308 supports a triple-channel architecture. Increasing the number of channels (e.g., instances of memory) increases the data rate of communication between the memory 308 and the compute device 302. Additional or alternative architectures may also be supported by the memory 308 such as a dual-channel architecture (e.g., two instances of memory), a quad-channel architecture (e.g., four instances of memory), a hexa-channel architecture (e.g., six instances of memory), an octa-channel architecture (e.g., eight instances of memory), or a dodeca-channel architecture (e.g., 12 instances of memory).

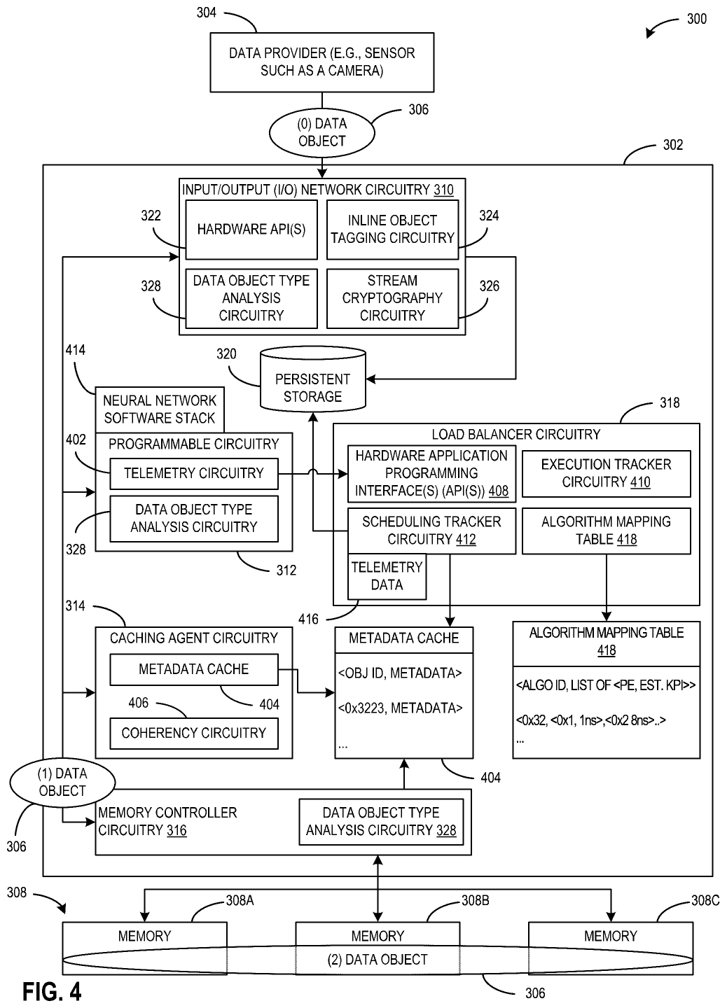

FIG. 4 is a block diagram of the system 300 of FIG. 3 depicting an example implementation of the programmable circuitry 312, the caching agent circuitry 314, the memory controller circuitry 316, and the load balancer circuitry 318 of FIG. 3. In the example of FIG. 4, the programmable circuitry 312 includes example telemetry circuitry 402 and an instance of the data object type analysis circuitry 328. One or more of the example telemetry circuitry 402 or the example data object type analysis circuitry 328 is implemented by one or more chiplets and/or one or more tiles either alone or in combination with other programmable circuitry. In the example of FIG. 4, the caching agent circuitry 314 includes an example metadata cache 404 and example coherency circuitry 406. One or more of the example metadata cache 404 or the example coherency circuitry 406 is implemented by one or more chiplets and/or one or more tiles either alone or in combination with other programmable circuitry.

In the illustrated example of FIG. 4, the memory controller circuitry 316 includes an instance of the data object type analysis circuitry 328. For example, the data object type analysis circuitry 328 is implemented by one or more chiplets and/or one or more tiles either alone or in combination with other programmable circuitry. In some examples, the memory controller circuitry 316 also includes instances of the metadata cache 404 or the coherency circuitry 406. In the example of FIG. 4, the load balancer circuitry 318 includes at least one example hardware API 408, example execution tracker circuitry 410, and example scheduling tracker circuitry 412. One or more of the at least one example hardware API 408, the example execution tracker circuitry 410, or the example scheduling tracker circuitry 412 is implemented by one or more chiplets and/or one or more tiles either alone or in combination with other programmable circuitry.

In the illustrated example of FIG. 4, the programmable circuitry 312 executes an OS of the compute device 302. For example, the OS is a bare metal OS. As used herein, a bare metal OS refers to an OS that has access to the physical resources (e.g., hardware and/or firmware) of a compute device (e.g., the compute device 302). In some examples, the bare metal OS corresponds to a host OS that executes on the compute device 302 to provide applications with access to the physical resources of the compute device 302. In some examples, the bare metal OS is a physical OS that executes below a virtual OS on the compute device 302 and that provides the virtual OS with access to the physical resources of the compute device 302.

In the illustrated example of FIG. 4, the programmable circuitry 312 also executes software such as an example neural network (NN) software stack 414 run by an end-user. For example, the NN software stack 414 corresponds to an AI/ML model and/or processing flow to operate an AI/ML model such as the processing flow 100 of FIG. 1 and/or the processing flow 200 of FIG. 2. In some examples, the NN software stack 414 is developed by the end-user. Additionally or alternatively, the NN software stack 414 is developed by a third party and executed by the end-user.

As described above, in a 68-core processor, the programmable circuitry 312 is implemented by 64 cores of the processor. More generally, the programmable circuitry 312 is implemented by one or more programmable circuits. Example programmable circuits include programmable circuitry such as one or more programmable microprocessors (e.g., CPUs, FPGAs, GPUs, DSPs, XPUs, Network Processing Units (NPUs), one or more microcontrollers, and/or integrated circuits such as ASICs. For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., API(s) that may assign computing task(s) to whichever one(s) of the multiple types of programmable circuitry is/are suited and available to perform the computing task(s).

In some examples, programmable circuitry may be referred to as an accelerator circuit. An accelerator circuit is programmable circuitry that has been designed to improve (e.g., reduce the processing time and/or increase the efficiency of) performance of a computing task as compared to, for example, a CPU. Example accelerator circuits include GPUs, DSPs, FPGAs, ASICs, field programmable analog arrays (FPAAs), sound cards, NPUs, network interface circuitry (NIC), cryptography circuitry, AI/ML circuitry such as vision processor units (VPUs) and tensor processor units (TPUs), and DPUs, among others.

In the illustrated example of FIG. 4, the telemetry circuitry 402 generates example telemetry data 416 for the one or more programmable circuits of the programmable circuitry 312. For example, the telemetry data 416 includes respective processing loads of the one or more programmable circuits, respective power consumption of the one or more programmable circuits, and respective counts of errors (e.g., itemized as recoverable and non-recoverable errors) of the one or more programmable circuits, among others. In the example of FIG. 4, the telemetry circuitry 402 reports the telemetry data 416 to the load balancer circuitry 318. Based on the telemetry data 416, the load balancer circuitry 318 determines at least one programmable circuit at which to schedule an algorithm (e.g., the NN software stack 414) on the programmable circuitry 312 as described herein.

In the illustrated example of FIG. 4, the programmable circuitry 312 can access the load balancer circuitry 318 to request scheduling of an algorithm to process data. In the example of FIG. 4, the programmable circuitry 312 accesses the scheduling tracker circuitry 412 via the at least one hardware API 408 of the load balancer circuitry 318 to request scheduling. For example, based on an instruction in an ISA of the programmable circuitry 312, the programmable circuitry 312 can request, via the at least one hardware API 408, the scheduling tracker circuitry 412 to schedule an algorithm to process the data object 306 with a given SLO and/or a given SLA.

In the illustrated example of FIG. 4, the at least one hardware API 408 is implemented similarly to the at least one hardware API 322. In the example of FIG. 4, the at least one hardware API 408 allows the programmable circuitry 312 request scheduling of an algorithm to process a data object as described above. In examples disclosed herein, the at least one hardware API 408 permits the programmable circuitry 312 to specify a pointer to a data object to be processed, an SLO and/or an SLA associated with processing the data object, and an identifier of the algorithm with which the data object is to be processed. In the example of FIG. 4, the SLO and/or the SLA can be specified in terms of a KPI to be satisfied based on processing of the data object (e.g., a target processing time, a target bandwidth, etc.).

In the illustrated example of FIG. 4, based on a request from the programmable circuitry 312, the scheduling tracker circuitry 412 determines whether an algorithm identified in the request is permitted to access a data object identified in the request. For example, the scheduling tracker circuitry 412 accesses an identifier (e.g., a UUID) of the algorithm that is to process the data object. Additionally, based on the request, the scheduling tracker circuitry 412 cross-references the identifier of the algorithm with the access control list for the data object identified in the request. As described above, during registration of a data stream with the I/O network circuitry 310, the data provider 304 can specify an access control list for one or more data objects of the data stream.

Example access controls can specify the permissions of one or more entities to access some or all of a data object. For example, the access control list for a data object specifies whether a data consumer can access all of the raw data of a data object identified in a request. Additionally or alternatively, the access control list for a data object specifies whether a data consumer can access the metadata of a data object identified in a request. By cross-referencing an identifier of an algorithm included in a request with an access control list for a data object identified in the request, the scheduling tracker circuitry 412 determines whether to process the request to schedule the algorithm to process the data object.

In some examples, the programmable circuitry 312 interacts with the scheduling tracker circuitry 412 via the at least one hardware API 408 over multiple communications to submit a request to schedule an algorithm to process a data object.

That is, the programmable circuitry 312 can discover characteristics of stored data objects by communicating with the scheduling tracker circuitry 412 via the at least one hardware API 408 and utilize the discovered characteristics to formulate a request to schedule an algorithm to process a data object. For example, via the at least one hardware API 408, the programmable circuitry 312 can request that the scheduling tracker circuitry 412 return a listing of the different types of data objects stored in the memory 308 or a count of the number of a specified type of data object, among other information. Based on the returned information, the programmable circuitry 312 can formulate a request to schedule an algorithm to process a data object.

In the illustrated example of FIG. 4, based on a request from the programmable circuitry 312, the scheduling tracker circuitry 412 determines at least one SLO and/or at least one SLA for a data object to be processed. Additionally, based on the request, the scheduling tracker circuitry 412 accesses metadata associated with the data object to determine at least one characteristic of the data object. For example, the scheduling tracker circuitry 412 utilizes the pointer provided in the request to access the data object from the memory 308 and/or from the metadata cache 404. In the example of FIG. 4, based on the request, the execution tracker circuitry 410 determines the telemetry data 416 for the one or more programmable circuits of the programmable circuitry 312. For example, the execution tracker circuitry 410 interfaces with the telemetry circuitry 402 via the at least one hardware API 408 to determine the telemetry data 416 (e.g., substantially real time telemetry data).

In the illustrated example of FIG. 4, based on a request from the programmable circuitry 312, the scheduling tracker circuitry 412 accesses an example algorithm mapping table 418 stored in the persistent storage 320. In the example of FIG. 4, the algorithm mapping table 418 maps an algorithm to respective types of programmable circuits capable of performing the algorithm and at least one KPI for the respective types of programmable circuits, where respective KPIs correspond to a data object characteristic. For example, the algorithm mapping table 418 includes entries for each algorithm implementation where each entry includes an identifier for an algorithm (e.g., implementation of an algorithm), at least one programmable circuit capable of implementing the algorithm, and at least one estimated KPI for the at least one programmable circuit where respective estimated KPIs correspond to a data object characteristic. In the example of FIG. 4, the algorithm mapping table 418 includes entries having an identifier of an algorithm (e.g., ALGO ID) and a list of programmable circuits capable of implementing the algorithm and estimated KPIs for the programmable circuits. For example, a first entry of the algorithm mapping table 418 of FIG. 4 includes an identifier “0×32” of an algorithm and a list of programmable circuits capable of implementing the algorithm including (1) a first programmable circuit having an identifier “0×1” with an estimated KPI of 1 nanosecond (ns) for target processing time and (b) a second programmable circuit having an identifier “0×2” with an estimated KPI of 8 ns for target processing time.

In the illustrated example of FIG. 4, based on a request to schedule an algorithm to process a data object, the scheduling tracker circuitry 412 selects at least one of the one or more programmable circuits of the programmable circuitry 312 that is best for a particular KPI (e.g., identified in the request) and characteristic of the data object (e.g., identified in the associated metadata). For example, the scheduling tracker circuitry 412 selects at least one of the one or more programmable circuits of the programmable circuitry 312 to implement the algorithm based on at least one SLO and/or SLA identified in the request, metadata of the data object, the telemetry data 416, and the algorithm mapping table 418. In some examples, if the algorithm mapping table 418 indicates that two or more programmable circuits are capable of performing the algorithm with similar estimated KPIs for a given data object characteristic, the scheduling tracker circuitry 412 selects one of the two or more programmable circuits that has less errors (e.g., a smaller number of errors, a greater percentage of recoverable errors, etc.) based on the telemetry data 416. In the example of FIG. 4, based on the schedule provided by the scheduling tracker circuitry 412, the selected programmable circuit of the programmable circuitry 312 implements the algorithm to process the data object.

In the illustrated example of FIG. 4, as the programmable circuitry 312 processes data objects, the programmable circuitry 312 generates data. For example, if the NN software stack 414 classifies image data objects, the NN software stack 414 produces a data object including one or more classifications of one or more image data objects. To facilitate on-the-fly analysis of data as the data is generated, each of the programmable circuitry 312 and the memory controller circuitry 316 includes an instance of the data object type analysis circuitry 328 as described above.

In examples where a data object is generated by a single programmable circuit of the programmable circuitry 312, the data object type analysis circuitry 328 of that programmable circuit analyzes the data object in line with the programmable circuit. For example, the data object type analysis circuitry 328 of the programmable circuit analyzes the data object as the data object traverses from the programmable circuit to the memory 308. Additionally or alternatively, in examples where a data object is generated in a distributed manner by multiple programmable circuits, the data object type analysis circuitry 328 of the memory controller circuitry 316 analyzes the data object. For example, the data object type analysis circuitry 328 of the memory controller circuitry 316 analyzes the data object after respective portions of the data object from the multiple programmable circuits are received.

In some examples, respective instances of the data object type analysis circuitry 328 across multiple instances of the memory controller circuitry 316 cooperate to analyze the data object. After analysis of a data object, the programmable circuitry 312 and/or the memory controller circuitry 316 cause storage of metadata for the data object. For example, the programmable circuitry 312 and/or the memory controller circuitry 316 cause storage of the metadata in a corresponding memory location where the data object starts in the memory 308 (e.g., in a region that includes error correcting code (ECC) bits).

In the illustrated example of FIG. 4, the caching agent circuitry 314 includes the metadata cache 404 to store metadata associated with one or more data objects. In the example of FIG. 4, the metadata cache 404 is implemented as cache memory such as static RAM (SRAM). For example, the metadata cache 404 is implemented as at least one of level one (L1) cache, level two (L2) cache, or level three (L3) cache. In the example of FIG. 4, the metadata cache 404 includes entries for each data object that has been analyzed by the data object type analysis circuitry 328. For example, cach entry includes an identifier for a data object and metadata identifying at least one characteristic of the data object. In the example of FIG. 4, the coherency circuitry 406 maintains consistency between metadata for data objects stored in the metadata cache 404 and the memory 308. As such, metadata of data objects stored in the metadata cache 404 is consistent with metadata of corresponding data objects stored in the memory 308.

In the illustrated example of FIG. 4, if a data object stored in the memory 308 is updated in a manner that causes metadata of the data object to be outdated, one or more instances of the data object type analysis circuitry 328 re-analyzes, re-evaluates, and/or re-scans the data object to update corresponding metadata to reflect up-to-date characteristic(s) of the data object. For example, image filters and similar image processing functions are common in Al image processing pipelines. As such, if the NN software stack 414 implements an Al image processing pipeline, the NN software stack 414 will likely process an image using a filter or similar type of image processing function to generate an updated image. Additionally or alternatively, the NN software stack 414 may process an image to change the resolution of the image.

In the illustrated example of FIG. 4, if a data object in the memory 308 is updated, the data object type analysis circuitry 328 of the memory controller circuitry 316 coordinates re-scanning of the data object across each memory channel (e.g., the first memory 308A, the second memory 308B, and the third memory 308C). In the example of FIG. 4, each instance of the data object type analysis circuitry 328 is also implemented with at least one hardware API (e.g., implemented similarly to the at least one hardware API 322). For example, the at least one hardware API of the memory controller circuitry 316 allows a software stack that updates a data object to trigger re-scanning of the data object.

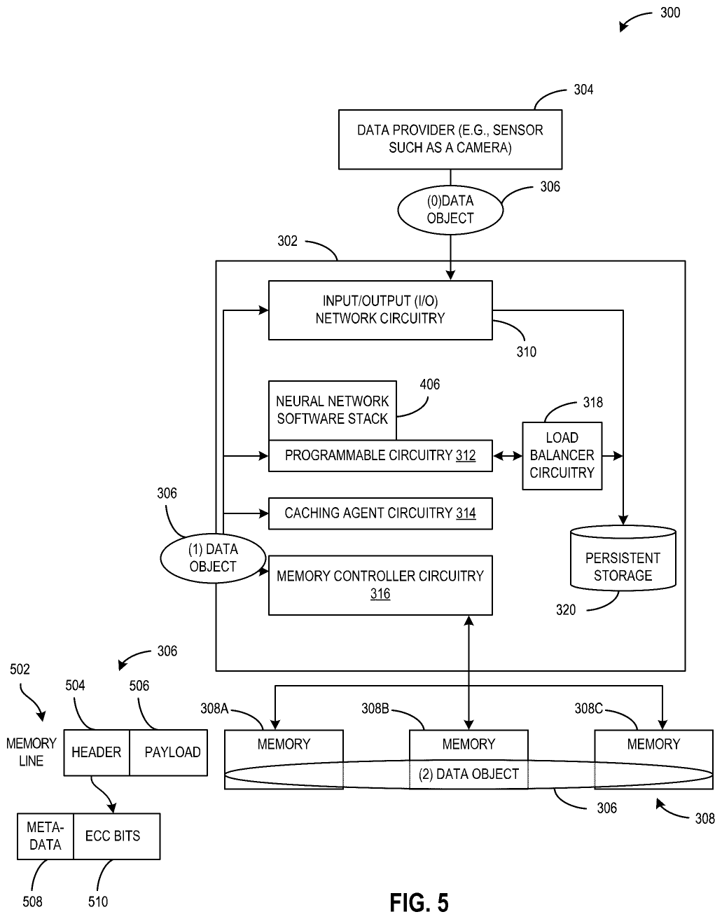

FIG. 5 is a block diagram of the system 300 of FIG. 3 depicting an example data structure 502 of the data object 306 of FIG. 3. In the example of FIG. 5, the data structure 502 of the data object 306 includes an example header 504 and an example payload 506. For example, the header 504 includes information regarding the payload 506 and the payload 506 includes data to be processed when the data object 306 is processed (e.g., by the programmable circuitry 312). In the example of FIG. 5, the header 504 includes example metadata 508 and example error correcting code (ECC) bits 510. The example ECC bits 510 facilitate detection and correction of errors in the payload 506. In the example of FIG. 5, instead of the header 504 of the data object 306 including exclusively the ECC bits 510, the header 504 is partitioned to also include the metadata 508.

In the illustrated example of FIG. 5, the metadata 508 identifies at least one characteristic of the data object 306 such as the data type of the data object 306. For example, the metadata 508 of the data object 306 is stored in the first (e.g., initial) line of the region of the memory 308 in which the data object 306 is stored. As such, one or more entities of the compute device 302 (e.g., software executed by the programmable circuitry 312, the load balancer circuitry 318, etc.) can access the metadata 508. In some examples, the data object 306 includes different parts. For example, different parts of the data object 306 are stored in different channels of the memory 308.

In such examples, the data object type analysis circuitry 328 accesses the parts of the data object 306 sequentially and characterizes the data object 306 per part. Additionally, in such examples, the metadata 508 of the data object 306 is stored in the first (e.g., initial) line of the region of the memory 308 in which the first (e.g., initial) part of the data object 306 is stored. In some examples, the metadata 508 is stored separately from the data object 306. For example, the metadata 508 is stored in a different region of the memory 308 from the region of the memory 308 in which the data object 306 is stored. Additionally or alternatively, the metadata 508 is stored in other media (e.g., the metadata cache 404) and not in the memory 308 as part of the data object 306.

In some examples, the programmable circuitry 312 also implements an instance of the inline object tagging circuitry 324 and an instance of the stream cryptography circuitry 326. Additionally or alternatively, the memory controller circuitry 316 implements an instance of the inline object tagging circuitry 324 and an instance of the stream cryptography circuitry 326. As such, the compute device 302 supports example pre-processing of data objects described herein regardless of where the data objects originate.

For example, for a data stream coming from storage (e.g., a PCIe-connected storage) directly to the memory 308, the inline object tagging circuitry 324, the stream cryptography circuitry 326, and the data object type analysis circuitry 328 of the memory controller circuitry 316 performs pre-processing of the data stream. In some examples, for a data stream generated by one or more programmable circuits (e.g., cores, accelerators, etc.) of the programmable circuitry 312, the inline object tagging circuitry 324, the stream cryptography circuitry 326, and the data object type analysis circuitry 328 of the programmable circuitry 312 performs pre-processing of the data stream. Additionally or alternatively, for a data stream generated by one or more programmable circuits (e.g., cores, accelerators, etc.) of the programmable circuitry 312, the inline object tagging circuitry 324, the stream cryptography circuitry 326, and the data object type analysis circuitry 328 of the memory controller circuitry 316 performs pre-processing of the data stream.

In some examples, the compute device 302 includes example memory interface circuitry in the communication path between the memory controller circuitry 316 and the memory 308. For example, the memory interface circuitry is implemented by one or more chiplets and/or one or more tiles either alone or in combination with other programmable circuitry. In such examples, the memory interface circuitry includes an instance of the data object type analysis circuitry 328. Additionally or alternatively, the memory interface circuitry includes an instance of the inline object tagging circuitry 324 and an instance of the stream cryptography circuitry 326. One or more of the example data object type analysis circuitry 328, the example inline object tagging circuitry 324, or the example stream cryptography circuitry 326 of the memory interface circuitry is implemented by one or more chiplets and/or one or more tiles either alone or in combination with other programmable circuitry.

In some examples, each of the first memory 308A, the second memory 308B, and the third memory 308C includes an instance of the data object type analysis circuitry 328. Additionally or alternatively, each of the first memory 308A, the second memory 308B, and the third memory 308C includes an instance of the inline object tagging circuitry 324 and an instance of the stream cryptography circuitry 326. One or more of the example data object type analysis circuitry 328, the example inline object tagging circuitry 324, or the example stream cryptography circuitry 326 of respective instances of the memory 308 is implemented by one or more chiplets and/or one or more tiles either alone or in combination with other programmable circuitry (e.g., within the form factor of respective instances of the memory 308).

In examples where respective instances of the memory 308 include an instance of the data object type analysis circuitry 328, the data object type analysis circuitry 328 analyzes the data object 306 as described herein. For example, the data object 306 is interleaved across respective instances of the memory 308 so that each instance of the data object type analysis circuitry 328 can access the data object 306 independently to perform analysis described herein. When triggered to re-scan a data object, instances of the data object type analysis circuitry 328 in respective channels of the memory 308 work together to re-scan the data object and determine whether a characteristic of the data object is to be updated.

For example, cach instance of the data object type analysis circuitry 328 coordinates analysis of a part of a data object stored in the corresponding channel of the memory 308 with other instances of the data object type analysis circuitry 328 stored in other channels of the memory 308. That is, each instance of the data object type analysis circuitry 328 analyzes the part of the data object having a header stored in the channel of the memory 308 corresponding to that instance of the data object type analysis circuitry 328. Instances of data object type analysis circuitry 328 in different channels of the memory 308 coordinate the analysis of respective parts of a data object. For example, the instances of the data object type analysis circuitry 328 in different channels of the memory 308 are interconnected via an interposer to facilitate communication.

In some examples, one or more instances of the data object type analysis circuitry 328 is implemented by an AI agent. An AI agent is hardware, software, and/or firmware that is capable of autonomously performing a task. For example, an AI agent is implemented by at least one AI/ML model such as an NN (e.g., a CNN, an RNN, an LSTM network, a DBN, an autoencoder network, an encoder-decoder network, a GAN, an RBFN, an MLP network, a large-language model (LLM), etc.). An AI agent can be implemented as a simple reflex agent, a model-based reflex agent, a goal-based agent, a utility-based agent, or a learning agent, among others. In some examples, an AI agent can be updated after deployment, (e.g., by an administrator of a compute deployment, by a provider of the AI agent, etc.).

A simple reflex agent refers to an AI agent that takes actions based on presently available information. As such, a simple reflex agent may not utilize memory or interact with other agents (if the simple reflex agent is missing information in an input). A model-based reflex agent refers to an AI agent that takes actions based on presently available information and memory to maintain a model of an environment in which the AI agent is deployed. As such, a model-based reflex agent can be updated as new information is received or learned.

A goal-based agent refers to an AI agent that includes a model of an environment in which the AI model is deployed. A goal-based agent takes actions based on the model and at least one goal. As such, a goal-based agent can search for a sequences of actions to achieve a goal. A utility-based agent refers to an AI agent that selects a sequence of actions to achieve at least one goal and to increase (e.g., maximize) utility, for example, measured by a reward function.

A learning agent refers to an AI agent that can learn from new information autonomously. A learning agent can be goal-based or utility-based in reasoning. A learning agent includes (1) a learner to learn from an environment in which the learning agent is deployed, (2) a critic to provide feedback on at least one action taken by the learning agent satisfied a threshold (e.g., reward, goal, etc.), (3) an actor to select an action to be performed by the learning agent, and (4) an action generator to propose at least one candidate action to be taken. As such, learning agents can achieve better performance than other AI agents in unfamiliar environments.

In some examples, circuitry may include one or more of the I/O network circuitry 310 of FIGS. 3, 4, and/or 5, the programmable circuitry 312 of FIGS. 3, 4, and/or 5, and/or the memory controller circuitry 316 of FIGS. 3, 4, and/or 5. In some examples, programmable circuit may include the load balancer circuitry 318 of FIGS. 3, 4, and/or 5. In some examples, circuitry and programmable circuit are used interchangeably. Some examples include more than one programmable circuit implementing the same or different ones of the I/O network circuitry 310 of FIG. 3, 4, and or 5, the programmable circuitry 312 of FIGS. 3, 4, and/or 5, the memory controller circuitry 316 of FIGS. 3, 4, and/or 5, and/or the load balancer circuitry 318 of FIGS. 3, 4, and/or 5.

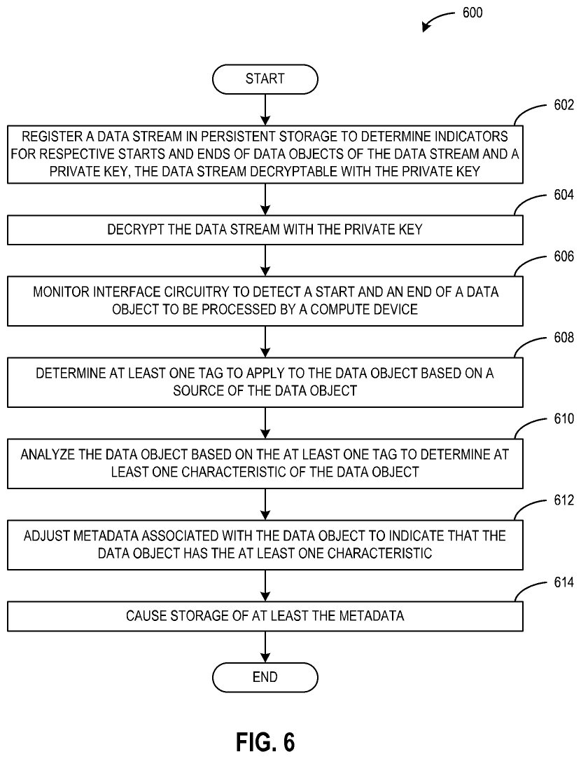

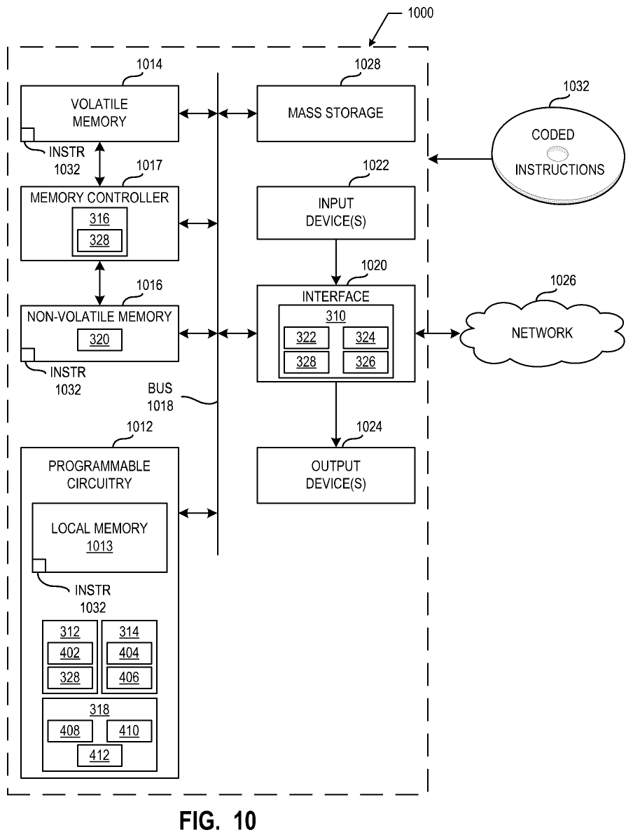

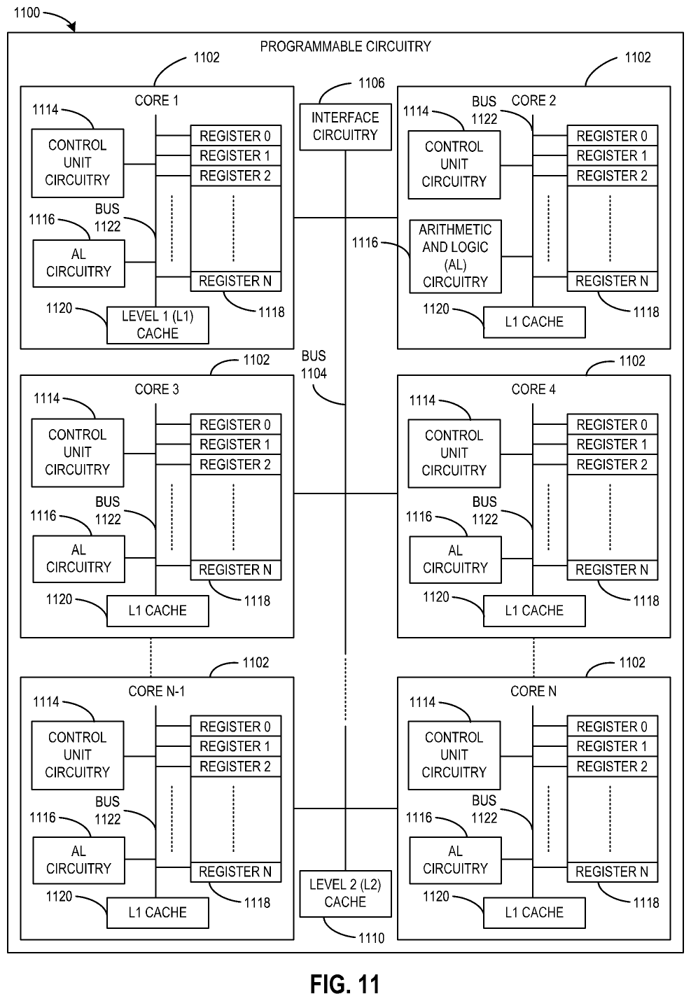

In some examples, the inline object tagging circuitry 324 is instantiated by programmable circuitry executing object tagging instructions and/or configured to perform operations such as those represented by the flowchart(s) of FIG. 6. In some examples, the I/O network circuitry 310 includes means for tagging a data object. For example, the means for tagging may be implemented by the inline object tagging circuitry 324. In some examples, the inline object tagging circuitry 324 may be instantiated by programmable circuitry such as the example programmable circuitry 1012 of FIG. 10. For instance, the inline object tagging circuitry 324 may be instantiated by the example microprocessor 1100 of FIG. 11 executing machine-executable instructions such as those implemented by at least blocks 602, 606, 608, 612, and 614 of FIG. 6.

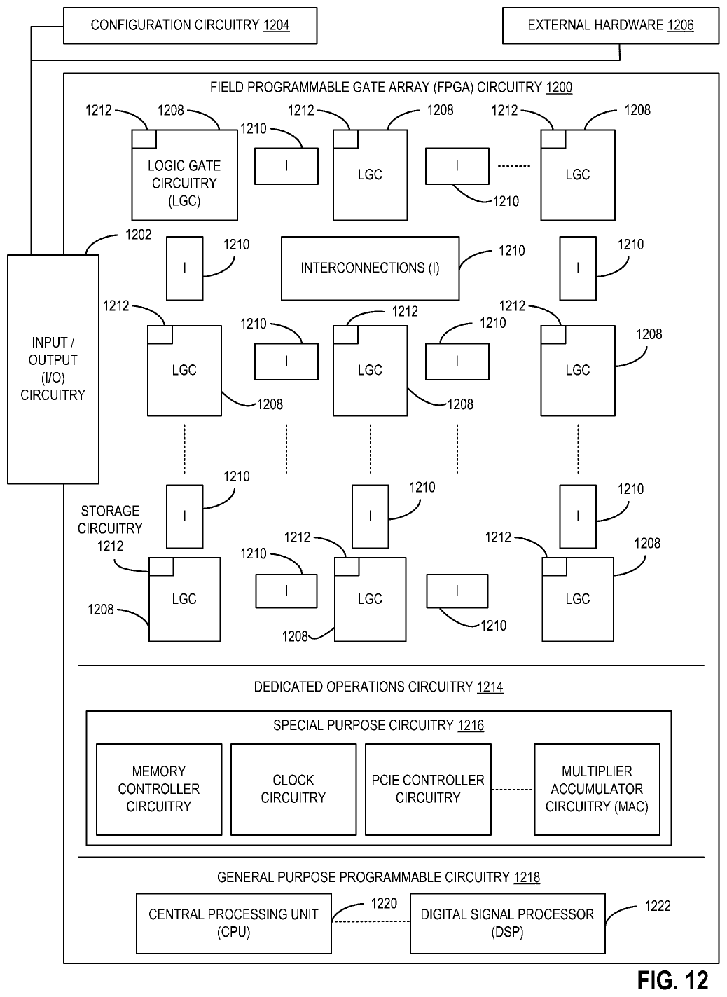

In some examples, the inline object tagging circuitry 324 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the inline object tagging circuitry 324 may be instantiated by any other combination of hardware, software, and/or firmware. For example, the inline object tagging circuitry 324 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the stream cryptography circuitry 326 is instantiated by programmable circuitry executing cryptography instructions and/or configured to perform operations such as those represented by the flowchart(s) of FIG. 6. In some examples, the I/O network circuitry 310 includes means for decrypting a data stream. For example, the means for decrypting may be implemented by the stream cryptography circuitry 326. In some examples, the stream cryptography circuitry 326 may be instantiated by programmable circuitry such as the example programmable circuitry 1012 of FIG. 10. For instance, the stream cryptography circuitry 326 may be instantiated by the example microprocessor 1100 of FIG. 11 executing machine-executable instructions such as those implemented by at least block 604 of FIG. 6.

In some examples, the stream cryptography circuitry 326 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the stream cryptography circuitry 326 may be instantiated by any other combination of hardware, software, and/or firmware. For example, the stream cryptography circuitry 326 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the data object type analysis circuitry 328 is instantiated by programmable circuitry executing data object analyzing instructions and/or configured to perform operations such as those represented by the flowchart(s) of FIG. 6. In some examples, the I/O network circuitry 310 includes means for determining at least one characteristic of a data object. For example, the means for determining may be implemented by the data object type analysis circuitry 328. In some examples, the data object type analysis circuitry 328 may be instantiated by programmable circuitry such as the example programmable circuitry 1012 of FIG. 10. For instance, the data object type analysis circuitry 328 may be instantiated by the example microprocessor 1100 of FIG. 11 executing machine-executable instructions such as those implemented by at least block 610 of FIG. 6.

In some examples, the data object type analysis circuitry 328 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the data object type analysis circuitry 328 may be instantiated by any other combination of hardware, software, and/or firmware. For example, the data object type analysis circuitry 328 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

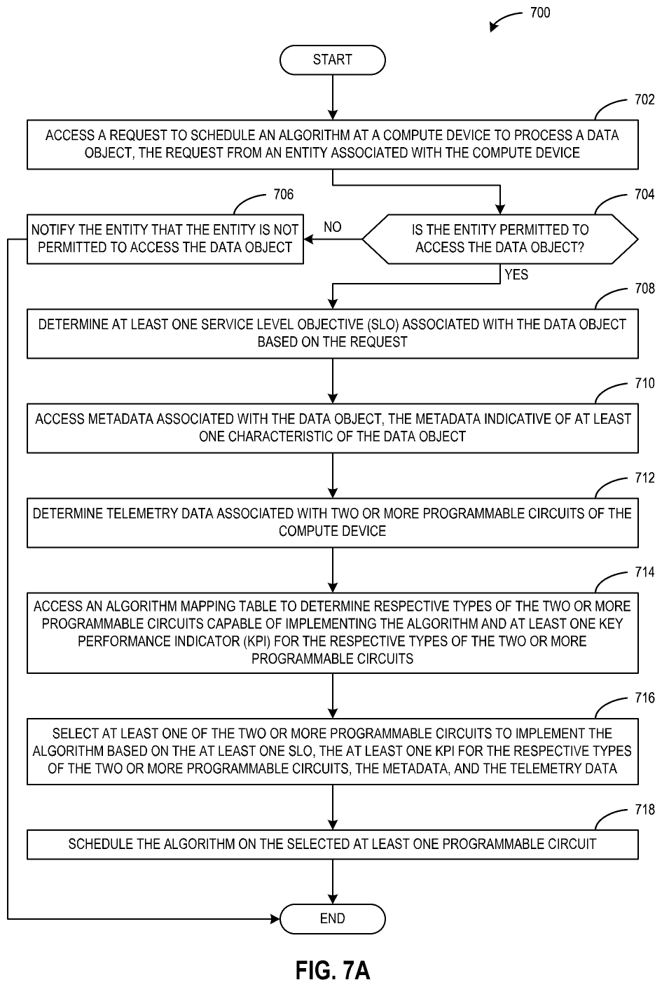

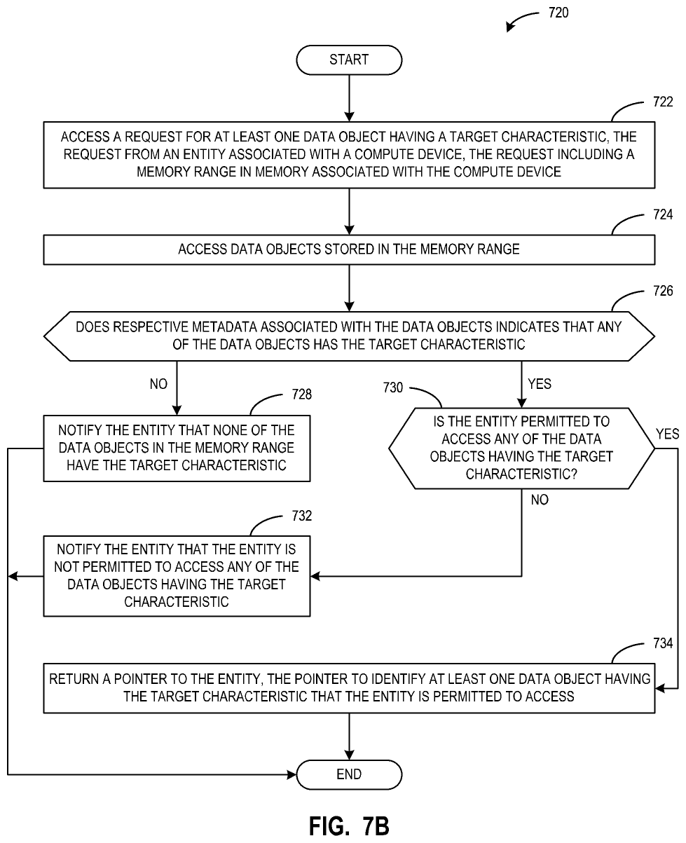

In some examples, the execution tracker circuitry 410 is instantiated by programmable circuitry executing telemetry tracking instructions and/or configured to perform operations such as those represented by the flowchart(s) of FIG. 7A. In some examples, the load balancer circuitry 318 includes means for determining telemetry data. For example, the means for determining may be implemented by the execution tracker circuitry 410. In some examples, the execution tracker circuitry 410 may be instantiated by programmable circuitry such as the example programmable circuitry 1012 of FIG. 10. For instance, the execution tracker circuitry 410 may be instantiated by the example microprocessor 1100 of FIG. 11 executing machine-executable instructions such as those implemented by at least block 712 of FIG. 7A.

In some examples, the execution tracker circuitry 410 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the execution tracker circuitry 410 may be instantiated by any other combination of hardware, software, and/or firmware. For example, the execution tracker circuitry 410 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the scheduling tracker circuitry 412 is instantiated by programmable circuitry executing scheduling instructions and/or configured to perform operations such as those represented by the flowchart(s) of FIG. 7A and 7B. In some examples, the load balancer circuitry 318 includes means for selecting at least one of two or more programmable circuits to implement an algorithm to process a data object. For example, the means for selecting may be implemented by the scheduling tracker circuitry 412. In some examples, the scheduling tracker circuitry 412 may be instantiated by programmable circuitry such as the example programmable circuitry 1012 of FIG. 10. For instance, the scheduling tracker circuitry 412 may be instantiated by the example microprocessor 1100 of FIG. 11 executing machine-executable instructions such as those implemented by at least blocks 702, 704, 706, 708, 710, 714, 716, and 718 of FIG. 7A.

In some examples, the load balancer circuitry 318 includes means for identifying at least one data object having a target characteristic. For example, the means for identifying may be implemented by the scheduling tracker circuitry 412. In some examples, the scheduling tracker circuitry 412 may be instantiated by programmable circuitry such as the example programmable circuitry 1012 of FIG. 10. For instance, the scheduling tracker circuitry 412 may be instantiated by the example microprocessor 1100 of FIG. 11 executing machine-executable instructions such as those implemented by at least blocks 722, 724, 726, 728, 730, 732, and 734 of FIG. 7B.

In some examples, the scheduling tracker circuitry 412 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the scheduling tracker circuitry 412 may be instantiated by any other combination of hardware, software, and/or firmware. For example, the scheduling tracker circuitry 412 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the I/O network circuitry 310 of FIG. 3 is illustrated in FIG. 3, one or more of the elements, processes, and/or devices illustrated in FIG. 3 may be combined, divided, re-arranged, omitted, eliminated, and/or implemented in any other way. Additionally, while example manners of implementing the programmable circuitry 312, the caching agent circuitry 314, the memory controller circuitry 316, and the load balancer circuitry 318 of FIG. 3 are illustrated in FIG. 4, one or more of the elements, processes, and/or devices illustrated in FIG. 4 may be combined, divided, re-arranged, omitted, eliminated, and/or implemented in any other way. Further, the at least one example hardware API 322, the example inline object tagging circuitry 324, the example stream cryptography circuitry 326, the example data object type analysis circuitry 328, and/or, more generally, the example I/O network circuitry 310 of FIGS. 3 and 4, and/or the example telemetry circuitry 402, the example data object type analysis circuitry 328, and/or, more generally, the example programmable circuitry 312 of FIG. 4, and/or the example metadata cache 404, the example coherency circuitry 406, and/or, more generally, the example caching agent circuitry 314 of FIG. 4, and/or the example data object type analysis circuitry 328, and/or, more generally, the example memory controller circuitry 316 of FIG. 4, and/or the at least one example hardware API 408, the example execution tracker circuitry 410, the example scheduling tracker circuitry 412, and/or, more generally, the example load balancer circuitry 318 of FIG. 4, may be implemented by hardware alone or by hardware in combination with software and/or firmware. Thus, for example, any of the at least one example hardware API 322, the example inline object tagging circuitry 324, the example stream cryptography circuitry 326, the example data object type analysis circuitry 328, and/or, more generally, the example I/O network circuitry 310 of FIGS. 3 and 4, and/or the example telemetry circuitry 402, the example data object type analysis circuitry 328, and/or, more generally, the example programmable circuitry 312 of FIG. 4, and/or the example metadata cache 404, the example coherency circuitry 406, and/or, more generally, the example caching agent circuitry 314 of FIG. 4, and/or the example data object type analysis circuitry 328, and/or, more generally, the example memory controller circuitry 316 of FIG. 4, and/or the at least one example hardware API 408, the example execution tracker circuitry 410, the example scheduling tracker circuitry 412, and/or, more generally, the example load balancer circuitry 318 of FIG. 4, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example I/O network circuitry 310 of FIGS. 3 and 4, the example programmable circuitry 312 of FIG. 4, the example caching agent circuitry 314 of FIG. 4, the example memory controller circuitry 316 of FIG. 4, and/or the example load balancer circuitry 318 of FIG. 4 may include one or more elements, processes, and/or devices in addition to, or instead of, those illustrated in FIGS. 3 and/or 4, and/or may include more than one of any or all of the illustrated elements, processes and devices.

Flowchart(s) representative of example machine-readable instructions, which may be executed by programmable circuitry to implement and/or instantiate the I/O network circuitry 310 of FIGS. 3 and 4, the programmable circuitry 312 of FIG. 4, the caching agent circuitry 314 of FIG. 4, the memory controller circuitry 316 of FIG. 4, and/or the load balancer circuitry 318 of FIG. 4 and/or representative of example operations which may be performed by programmable circuitry to implement and/or instantiate the I/O network circuitry 310 of FIGS. 3 and 4, the programmable circuitry 312 of FIG. 4, the caching agent circuitry 314 of FIG. 4, the memory controller circuitry 316 of FIG. 4, and/or the load balancer circuitry 318 of FIG. 4, are shown in FIGS. 6, 7A, and 7B. The machine-readable instructions may be one or more executable programs or portion(s) of one or more executable programs for execution by programmable circuitry such as the programmable circuitry 1012 shown in the example programmable circuitry platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically crasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 6, 7A, and 7B, many other methods of implementing the example I/O network circuitry 310, the example programmable circuitry 312, the example caching agent circuitry 314, the example memory controller circuitry 316, and/or the example load balancer circuitry 318 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., programmable circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a PLD, a GAL device, a PAL device, a CPLD, a SPLD, an MCU, a PSoC, etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 6, 7A, and 7B may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 6 is a flowchart representative of example machine-readable instructions and/or example operations 600 that may be executed, instantiated, and/or performed by example programmable circuitry to implement the I/O network circuitry 310 of FIGS. 3-5. In some examples, the machine-readable instructions and/or operations 600 of FIG. 6 may be executed, instantiated, and/or performed by programmable circuitry to implement one or more of the programmable circuitry 312 or the memory controller circuitry 316 of FIGS. 3-5. The example machine-readable instructions and/or the example operations 600 of FIG. 6 begin at block 602, at which the inline object tagging circuitry 324 registers a data stream in persistent storage of the compute device 302. For example, the data stream is to be stored in memory of the compute device 302.

For example, via the at least one hardware API 322, the inline object tagging circuitry 324 registers the data stream in the persistent storage 320 to determine (1) indicators for respective starts and ends of data objects of the data stream and (2) a private key with which the data stream is decryptable. In the example of FIG. 6, at block 604, the stream cryptography circuitry 326 decrypts the data stream with the private key. For example, upon receiving the registered data stream (e.g., detected via an identifier of the data stream) at the I/O network circuitry 310, the stream cryptography circuitry 326 decrypts the data stream with the private key to facilitate monitoring of the data stream.

In the illustrated example of FIG. 6, at block 606, the inline object tagging circuitry 324 monitors interface circuitry (e.g., the I/O network circuitry 310) to detect a start and an end of a data object to be processed by the compute device 302. For example, the inline object tagging circuitry 324 detects the start and the end of the data object based on information stored in the persistent storage 320 during registration of the data stream. In the example of FIG. 6, at block 608, the inline object tagging circuitry 324 determines at least one tag to apply to the data object. For example, the inline object tagging circuitry 324 determines at least one tag to apply to the data object based on a source of the data object.

In the illustrated example of FIG. 6, at block 610, the data object type analysis circuitry 328 analyzes the data object based on the at least one tag to determine at least one characteristic of the data object. Example characteristics of a data object include a data type of the data object and a level of sparsity of the data object. In some examples, a characteristic of a data object includes a null characteristic to indicate that the data object has no computationally relevant characteristic. For example, if a data object has characteristics that would allow any type of programmable circuitry to process the data object with similar efficiency, the data object type analysis circuitry 328 determines a null characteristic for the data object.

In some examples, the data object type analysis circuitry 328 identifies at least one sub-data object within a data object to determine at least one characteristic of the data object. For example, if a data object is an image, the data object type analysis circuitry 328 identifies sub-data objects including a foreground, a background, and at least one subject of the image. In this manner, the at least one characteristic for the data object can identify the at least one sub-data object determined by the data object type analysis circuitry 328. In the example of FIG. 6, at block 612, the inline object tagging circuitry 324 adjusts metadata associated with the data object. For example, the inline object tagging circuitry 324 adjusts the metadata to indicate that the data object has the at least one characteristic. At block 614, the inline object tagging circuitry 324 causes storage of at least the metadata (e.g., in the metadata cache 404, in the memory 308, etc.).

While the illustrated example of FIG. 6 depicts the example machine-readable instructions and/or the example operations 600 in a particular order, it should be understood that one or more of the processes illustrated in FIG. 6 may be combined, divided, re-arranged, omitted, eliminated, and/or implemented in any other way. For example, one or more of blocks 604, 606, 608, 610, 612, and 614 may be re-arranged, omitted, or eliminated. That is, in some examples, the I/O network circuitry 310 receives and stores data objects in the memory 308 without first performing analysis on the data objects. In such examples, an instance of the data object type analysis circuitry 328 may analyze data objects after the data objects are received by the compute device 302. For example, an instance of the data object type analysis circuitry 328 analyzes a data object based on a request for the load balancer circuitry 318 to schedule an algorithm to process a data object. Additionally or alternatively, an instance of the data object type analysis circuitry 328 analyzes a data object at an intermediate time between (1) when the data object is generated and/or received at the compute device 302 and (2) when a request is received for the load balancer circuitry 318 to schedule an algorithm to process the data object.

FIG. 7A is a flowchart representative of example machine-readable instructions and/or example operations 700 that may be executed, instantiated, and/or performed by example programmable circuitry to implement the load balancer circuitry 318 of FIGS. 3-5. The example machine-readable instructions and/or the example operations 700 of FIG. 7A begin at block 702, at which the scheduling tracker circuitry 412 accesses a request to schedule an algorithm at the compute device 302 to process a data object. For example, the scheduling tracker circuitry 412 accesses the request to schedule the algorithm via the at least one hardware API 408. In the example of FIG. 7A, the request is from an entity associated with the compute device 302.

In the illustrated example of FIG. 7A, at block 704, the scheduling tracker circuitry 412 determines whether the entity is permitted to access the data object. Based on (e.g., in response to), the scheduling tracker circuitry 412 determining that the entity is not permitted to access the data object (block 704: NO), the machine-readable instructions and/or the operations 700 proceed to block 706. At block 706, the scheduling tracker circuitry 412 notifies the entity that the entity is not permitted to access the data object. For example, via the at least one hardware API 408, the scheduling tracker circuitry 412 notifies the entity. Returning to block 704, based on (e.g., in response to), the scheduling tracker circuitry 412 determining that the entity is permitted to access the data object (block 704: YES), the machine-readable instructions and/or the operations 700 proceed to block 708.

In the illustrated example of FIG. 7A, at block 708, the scheduling tracker circuitry 412 determines at least one service level objective associated with the data object. For example, the scheduling tracker circuitry 412 determines the at least one SLO based on the request. In the example of FIG. 7A, at block 710, the scheduling tracker circuitry 412 accesses metadata associated with the data object. For example, the metadata of the data object is indicative of at least one characteristic of the data object. Example characteristics of a data object include a data type of the data object, a level of sparsity of the data object, and, if the data object is an image, at least one region in the image.

In the illustrated example of FIG. 7A, at block 712, the execution tracker circuitry 410 determines telemetry data associated with two or more programmable circuits of the compute device 302. For example, the execution tracker circuitry 410 interfaces with the telemetry circuitry 402 via the at least one hardware API 408 to access telemetry data associated with the programmable circuitry 312. In the example of FIG. 7A, at block 714, the scheduling tracker circuitry 412 accesses an algorithm mapping table to determine respective types of the two or more programmable circuits capable of implementing the algorithm and at least one key performance indicator for the respective types of the two or more programmable circuits. For example, the scheduling tracker circuitry 412 accesses the algorithm mapping table 418.

In the illustrated example of FIG. 7A, at block 716, the scheduling tracker circuitry 412 selects at least one of the two or more programmable circuits to implement the algorithm. For example, the scheduling tracker circuitry 412 selects the at least one of the two or more programmable circuits based on the at least one SLO, the at least one KPI for the respective types of the two or more programmable circuits, the metadata, and the telemetry data. In some examples, if the data object is an image having two or more images, the scheduling tracker circuitry 412 can select at least one of the two or more programmable circuits to process different regions of the image. For example, the scheduling tracker circuitry 412 can select a first programmable circuit to process a foreground of the image, a second programmable circuit to process the background of the image, and a third programmable circuit to process a subject of the image. In this manner, the scheduling tracker circuitry 412 can select at least one programmable circuit to process at least one sub-data object of a data object. In the example of FIG. 7A, at block 718, the scheduling tracker circuitry 412 schedules the algorithm on the selected at least one programmable circuit. For example, the scheduling tracker circuitry 412 provides the programmable circuitry 312 with a schedule to implement the algorithm on the selected at least one programmable circuit via the at least one hardware API 408.

While the illustrated example of FIG. 7A depicts the example machine-readable instructions and/or the example operations 700 in a particular order, it should be understood that one or more of the processes illustrated in FIG. 7A may be combined, divided, re-arranged, omitted, eliminated, and/or implemented in any other way. For example, one or more of blocks 710, 712, 714, 716, and 718 may be re-arranged, omitted, or eliminated. That is, in some examples, the load balancer circuitry 318 schedules an algorithm on at least one programmable circuit to process a data object as data objects are generated and/or received at the compute device 302.

FIG. 7B is a flowchart representative of example machine-readable instructions and/or example operations 720 that may be executed, instantiated, and/or performed by example programmable circuitry to implement the load balancer circuitry 318 of FIGS. 3-5 to respond to a request for at least one data object having a target characteristic. The example machine-readable instructions and/or the example operations 720 of FIG. 7B begin at block 722, at which the scheduling tracker circuitry 412 accesses a request for at least one data object having a target characteristic. For example, the request is from an entity associated with the compute device 302.

In the illustrated example of FIG. 7B, the request includes a memory range in memory associated with the compute device 302. For example, the NN software stack 414, executed by the programmable circuitry 312, communicates the request to the scheduling tracker circuitry 412 via the at least one hardware API 408. In the example of FIG. 7B, the request identifies a memory range in the memory and a target characteristic (e.g., 90% sparsity) of at least one data object to be returned to the entity that issued the request.

In the illustrated example of FIG. 7B, at block 724, the scheduling tracker circuitry 412 access data objects stored in the memory range. For example, via the at least one hardware API 408, the scheduling tracker circuitry 412 communicates with the memory controller circuitry 316 to access the data objects. In the example of FIG. 7B, at block 726, the scheduling tracker circuitry 412 determines whether respective metadata associated with the data objects indicates that any of the data objects has the target characteristic. For example, scheduling tracker circuitry 412 compares the target characteristic to at least one characteristic indicated in the respective metadata of the data objects.

In the illustrated example of FIG. 7B, based on (e.g., in response to) the scheduling tracker circuitry 412 determining that the respective metadata associated with the data objects indicates that none of the data objects have the target characteristic (block 726: NO), the machine-readable instructions and/or the operations 720 proceed to block 728. At block 728, based on none of the data objects having the target characteristic, the scheduling tracker circuitry 412 notifies the entity that none of the data objects in the memory range have the target characteristic. Returning to block 726, based on (e.g., in response to) the scheduling tracker circuitry 412 determining that the respective metadata associated with the data objects indicates that at least one of the data objects has the target characteristic (block 726: YES), the machine-readable instructions and/or the operations 720 proceed to block 730.

In the illustrated example of FIG. 7B, at block 730, the scheduling tracker circuitry 412 determines whether the entity is permitted to access any of the data objects having the target characteristic. Based on (e.g., in response to), the scheduling tracker circuitry 412 determining that the entity is not permitted to access any of the data objects having the target characteristic (block 730: NO), the machine-readable instructions and/or the operations 720 proceed to block 732. At block 732, the scheduling tracker circuitry 412 notifies the entity that the entity is not permitted to access any of the data objects having the target characteristic. For example, via the at least one hardware API 408, the scheduling tracker circuitry 412 notifies the entity.

Returning to block 730, based on (e.g., in response to), the scheduling tracker circuitry 412 determining that the entity is permitted to access at least one of the data objects having the target characteristic (block 730: YES), the machine-readable instructions and/or the operations 720 proceed to block 734. At block 734, the scheduling tracker circuitry 412 returns a pointer to the entity. For example, the pointer identifies at least one data object having the target characteristic that the entity is permitted to access. In the example of FIG. 7B, the scheduling tracker circuitry 412 returns the pointer to the entity via the at least one hardware API 408.

While the illustrated example of FIG. 7B depicts the example machine-readable instructions and/or the example operations 720 in a particular order, it should be understood that one or more of the processes illustrated in FIG. 7B may be combined, divided, re-arranged, omitted, eliminated, and/or implemented in any other way. For example, one or more of blocks 730 and 732 may be re-arranged, omitted, or eliminated. That is, in some examples, the load balancer circuitry 318 returns a pointer to at least one data object having a target characteristic included in a request without first verifying access permissions of an entity that provided the request. In such examples, the data objects may be secured in another manner, for example, via encryption or via the memory controller circuitry 316.

FIGS. 8, 9A, 9B, and 10 include example computing architectures in which any of the techniques and configurations above may be implemented.

FIG. 8 illustrates an example hardware arrangement of an example data center 800 used to provide multiple examples or instances of a computing system (e.g., the programmable circuitry platform 1000, described below), with each example of the computing system identified as a respective platform (e.g., the platform 830, described below). The data center 800 includes example data center infrastructure 801, an example data center network fabric 802, and an example power distribution unit 803 to support multiple racks of compute platforms, with a single instance of an example rack 810 depicted. The data center infrastructure 801 may provide physical components that host the compute platform hardware, storage components, and/or networking equipment. The data center network fabric 802 may include switches and/or networking components to support data flows among various compute platforms and storage devices throughout the data center. The power distribution unit 803 may include components to distribute and/or control power among the various compute platforms, networking, and storage devices.

The rack 810 of FIG. 8 includes, but is not limited to, example cooling infrastructure 811, an example network interface 812, and/or other related physical components to support discrete instances of multiple chassis. The rack 810 provides power, connectivity, and/or cooling to each of the multiple chassis in a single rack, with a single instance of a chassis 820 in the example of FIG. 8. The chassis 820 includes, but is not limited to, example cooling infrastructure 821, an example chassis network fabric 822, and an example power supply 823, which provides cooling, network connectivity, and/or power to multiple platforms within the chassis. Although a single instance of an example platform 830 is illustrated in FIG. 8, in some examples, a common data center rack configuration may include dozens of chassis, with each chassis to support a number of platforms depending on the physical size of the platform hardware and/or supporting equipment.

The platform 830 of FIG. 8 may be referred to as a server or node, depending on the use case for the platform 830 and the data center 800. The platform 830 includes but is not limited to examples of a discrete computing system hosted on a single board. In FIG. 8, the platform 830 is illustrated as hosting a first example chip assembly 840A and a second example chip assembly 840B on a first board provided by a printed circuitry board (PCB) or other platform board, shown as an example PCB 831. In some examples, the platform 830 may include only one chip package, whereas the PCB 831 includes interconnection of multiple chip assemblies via an interface (e.g., a peripheral component interconnect express (PCIe) interface). Additional chip packages and components may also be hosted on the PCB 831.

Some examples of the chip assembly 840A, 840B of FIG. 8 may be termed as a System-on-Chip (SoC) package, as modular chiplets that perform different functions are integrated into a single package-even though this chip package is composed of multiple dies unlike a traditional SoC design that uses a single die. Other examples of the chip assembly 840A, 840B may include a System-on-Package (SoP), System-in-a-Package (SiP), or other single chip packages. Various combinations of 2 dimension (D), 2.5D, and/or 3D packaging technologies may be used to manufacture and/or assemble the chip package and its underlying structure. Additionally, different manufacturing processes may be used to provide chiplets and components from different process nodes (e.g., semiconductor fabrication systems).

The first chip assembly 840A and the second chip assembly 840B of FIG. 8 are packages that include multiple chiplets and/or dies for respective functions, such as separate chiplets for processing (e.g., CPU or GPU chiplets), memory (e.g., cache or high-bandwidth memory chiplets), I/O (e.g., I/O chiplets), acceleration (e.g., AI/ML acceleration chiplets), signal processing (e.g., audio or video processing chiplets), etc. The close-up of chip assembly 840A of FIG. 8 includes a I/O Hub chiplet 841, chiplets 842, and a power supply 843. These components may be hosted on an interposer that is designed to connect multiple dies and/or components within a single semiconductor package (e.g., chip package). In some examples, the chiplets 842 may be manufactured and/or sourced separately and later assembled into the chip package to create the chip assembly 840A. Various connections may be provided among the chiplets 842, such as with the use of Universal Chiplet Interconnect Express (UCIe) interfaces and communications, and/or between chiplets and on-chip memory (e.g., high-bandwidth memory (HBM)) using HBM3 (JEDEC), Universal Memory Interface (UMI), or other memory interfaces.

FIG. 9A illustrates an example arrangement of an example chip assembly 940A (e.g., a multi-processing core example of the first chip assembly 840A or the second chip assembly 840B of FIG. 8), with expanded views of the chiplets and processing units included herein. In FIG. 9A the chip assembly 940A, which may constitute a SoC, SoP, SiP, and/or other type of chip package, includes chiplets such as an example chiplet 910A, an example chiplet 910B, etc. and associated on-package memory (e.g., high-speed memory) such as 3D-stacked, High Bandwidth Memory (HBM) instances (shown as an example HBM 920A, an example HBM 920B, interfaces (e.g., UCIe interfaces) shown as an example UCIe 921A, an example UCIe 921B, and an example I/O hub 930 (e.g., which may be implemented by a I/O chiplet). Other hardware elements of a chip package are not included for simplicity. Although the examples disclosed herein are described in conjunction with UCIe interfaces, one or more of the interfaces may be device-to-device (Dev2Dev) interfaces (e.g., CXLI, peripheral component interconnect express (PCIE)), die to die (D2D) interfaces (e.g., NVLINK), chiplet to chiplet (Ch2Ch) interfaces (e.g., universal chiplet interconnected express (UCIe)), core to core (C2C) interfaces (e.g., using coherency protocols), etc.

The chiplets 910A, 910B of FIG. 9A include multiple processing units and the example processing units 900A, 900B, 900C, 900D include one or multiple cores, respectively. For example, the chiplet 910A of FIG. 9A includes four processing units (the processing units 900A, 900B, 900C, 900D) and an example Level 3 (L3) cache 904. The processing units 900A, 900B, 900C, 900D may include one or multiple processing cores, one or multiple caches, other processing units and/or passive and/or active elements. For example, processing unit 900A includes two cores (an example core 901A and an example core 901B), vector processing unit 902, and an example level 2 (L2) cache 903. Accordingly, a single-core processing unit can provide four cores per chiplet and eight total cores in a two-chiplet chip assembly, whereas a dual-core processing unit can provide eight cores per chiplet and sixteen total cores in a two-chiplet chip assembly. However, examples disclosed herein may correspond to other permutations.

FIG. 9B is an example arrangement of an example chip assembly 940B (e.g., a multi-chiplet high-performance computing (HPC) example of chip assembly 840A, 840B), adapted for HPC applications (e.g., parallel processing operations involving thousands, millions, or more of processors and/or cores operating simultaneously). The example chip assembly 940B illustrates placement as a SiP, SoC, and/or other package onto a platform board (e.g., the PCB 831 of FIG. 8). The platform board may be in a data center (e.g., the data center 800 of FIG. 8) or in a standalone deployment setting (e.g., in a standalone computer system, mobile computing device, autonomous device, etc.).

The chip assembly 940B of FIG. 9B is composed of multiple chiplets, shown with four chiplets, including example chiplets 910C, 910D, 910E, 910F. The chiplets 910C, 910D, 910E, 910F include multiple processing units, such as thirty-two processing units with a corresponding level 3 (L3) cache for each processing unit. The processing units may include one or multiple cores, such as an example single-core processing unit 900E shown as part of the chiplet 910C. In some examples, the chiplets 910C, 910D, 910E, 910F include a variety of programmable circuitry. For example, the chiplet 910C may include multiple processor cores (e.g., CPUs), the chiplet 910D may include multiple GPUs, the chiplet 910E may include multiple VPUs, and the chiplet 910F may include multiple instances of any past, present, or future processor unit. The chip assembly 940B also includes corresponding memory resources, such as HBM elements corresponding to respective banks of processing units (e.g., HBM 920B and HBM 920C corresponding respective sets of processing units of chiplet 910C), UCIe interfaces, and/or an IO Hub.

As described herein, the chip assembly 940B is adapted for HPC applications such as parallel processing operations involving thousands, millions, or more of processors and/or cores operating simultaneously. In examples disclosed herein, the various processors and/or cores utilized for an HPC application may be implemented in one chiplet or multiple chiplets. Also, for example, the various processors and/or cores utilized for an HPC application may be implemented in one platform or multiple platforms. As such, the load balancer circuitry 318 can broker processing of one or more data objects in one chiplet, across multiple chiplets, in one platform, and/or across multiple platforms.

The chip assembly and related products or devices described herein may be configured in a variety of computing system examples. Such examples include non-transitory machine-readable media storing machine-readable instructions and one or more processors coupled to the memory, such that executing the machine-readable instructions configure one or more of the processors and/or implementing hardware (e.g., the processing unit 900, the chiplet 910, the chip 840, and/or the platform 830 of FIGS. 8, 9A, and/or 9B) to perform operations described above for electronic systems or devices (e.g., to perform the machine-readable instructions of the flowcharts of FIGS. 6, 7A, and 7B, etc.). It should be further understood that software, including one or more machine-readable instructions, that facilitate processing and operations as described above, may be distributed, installed, or otherwise provided to networked devices (e.g., servers or cloud computing systems). Alternatively, in some examples, the software may be obtained and loaded (or, re-loaded/upgraded) from one or more servers and/or cloud computing systems, such as software stored on a server for distribution over the Internet, for example.

FIG. 10 is a block diagram of an example programmable circuitry platform 1000 structured to execute and/or instantiate the example machine-readable instructions and/or the example operations of FIGS. 6, 7A, and 7B to implement the I/O network circuitry 310, the programmable circuitry 312, the caching agent circuitry 314, the memory controller circuitry 316, and/or the load balancer circuitry 318 of FIGS. 3 and/or 4. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, VPUs, DSPs, and/or microcontrollers from any desired family or manufacturer. In some examples, the programmable circuitry 1012 can be implemented by reduced instruction set computer (RISC)-V architecture and/or a chiplet (e.g., the chiplet assemblies 840A, 840B, 940A, 940B of FIGS. 8, 9A and/or 9B). The programmable circuitry 1012 may be implemented by one or more semiconductor based (e.g., silicon based) devices. In this example, the programmable circuitry 1012 implements the example telemetry circuitry 402, the example data object type analysis circuitry 328, and/or, more generally, the example programmable circuitry 312 of FIG. 4, and/or the example metadata cache 404, the example coherency circuitry 406, and/or, more generally, the example caching agent circuitry 314 of FIG. 4, and/or the at least one example hardware API 408, the example execution tracker circuitry 410, the example scheduling tracker circuitry 412, and/or, more generally, the example load balancer circuitry 318 of FIG. 4.

In some examples, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of first circuitry at one point in time and reused by a second circuit in the first circuitry, or by a third circuit in a second circuitry at a different time.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. In this example, the non-volatile memory 1016 implements the example persistent storage 320. Access to the main memory 1014, 1016 of the illustrated example is controlled by memory controller circuitry 1017. In some examples, the memory controller circuitry 1017 may be implemented by one or more integrated circuits, logic circuits, microcontrollers from any desired family or manufacturer, or any other type of circuitry to manage the flow of data going to and from the main memory 1014, 1016. In this examples, the memory controller circuitry 1017 implements the example data object type analysis circuitry 328, and/or, more generally, the example memory controller circuitry 316 of FIG. 4.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 1020 may include an output interface, such as an interface connected to a display device, an input interface such as an interface connected to an alphanumeric input device or a user interface (UI) navigation device, or a communication interface. In some examples, a connected I/O device may also include a display device, an alphanumeric input device, and/or a navigation device that is integrated into a single unit, such as a touch screen display. The communication interface may provide a connection with a network interface device used to transmit and/or receive electronic signals on the network 1026. The programmable circuitry platform 1000 may also include other interfaces or hardware in connection with a signal generation device (e.g., an audio or radio signal generation device), an output controller (e.g., for connection with a serial, universal serial bus (USB), parallel, and/or other wired or wireless connection such as which uses via infrared (IR) and/or near field communication (NFC) technologies), an input controller (e.g., for connection with sensors or peripheral devices), etc.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this examples, the interface circuitry 1020 implements the at least one example hardware API 322, the example inline object tagging circuitry 324, the example stream cryptography circuitry 326, the example data object type analysis circuitry 328, and/or, more generally, the example I/O network circuitry 310 of FIGS. 3 and 4.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1032, which may be implemented by the machine-readable instructions of FIGS. 6, 7A, and 7B, may be stored in the mass storage device 1028, in the volatile memory 1014, in the non-volatile memory 1016, and/or on at least one non-transitory computer-readable storage medium such as a CD or DVD which may be removable. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 1032.

The instructions 1032 may reside, during execution and/or other operation of the programmable circuitry platform 1000, completely, or at least partially, within the volatile memory 1014, within non-volatile memory 1016, within the local memory 1013, within a removable storage, within a non-removable storage, and/or within the programmable circuitry 1012. Thus, any combination of the programmable circuitry 1012, the volatile memory 1014, the non-volatile memory 1016, the local memory 1013, and/or a storage device of the removable storage or non-removable storage may constitute a machine-readable medium or media. The instructions 1032, when loaded and executed by the programmable circuitry 1012, may invoke or utilize a defined instruction set 1032 of the programmable circuitry 1012, such as a processor instruction set defined by an ISA of a reduced instruction set computer (RISC) or complex instruction set computer (CISC) architecture--including but not limited to the RISC-V Instruction Set provided in a RISC-V architecture. A RISC-V architecture and instruction set is one of several available architectures and instruction sets that may be used in examples of the compute components (e.g., the programmable circuitry 1012) described herein.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 6, 7A, and 7B to effectively instantiate the circuitry of FIGS. 3 and/or 4 as logic circuits to perform operations corresponding to those machine-readable instructions. In some such examples, the circuitry of FIGS. 3 and/or 4 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine-readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine-readable instructions and/or operations represented by the flowcharts of FIGS. 6, 7A, and 7B.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an LI data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry 1116 (sometimes referred to as an ALU), a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine-readable instructions. However, once configured, the FPGA circuitry 1200 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine-readable instructions represented by the flowchart(s) of FIGS. 6, 7A, and 7B but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 6, 7A, and 7B. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6, 7A, and 7B. As such, the FPGA circuitry 1200 may be configured and/or structured to effectively instantiate some or all of the operations/functions corresponding to the machine-readable instructions of the flowchart(s) of FIGS. 6, 7A, and 7B as dedicated logic circuits to perform the operations/functions corresponding to those software instructions in a dedicated manner analogous to an ASIC. Therefore, the FPGA circuitry 1200 may perform the operations/functions corresponding to the some or all of the machine-readable instructions of FIGS. 6, 7A, and 7B faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine-readable instructions of FIGS. 6, 7A, and 7B and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine-readable instructions represented by the flowchart(s) of FIGS. 6, 7A, and 7B to perform first operation(s)/function(s), the FPGA circuitry 1200 of FIG. 12 may be configured and/or structured to perform second operation(s)/function(s) corresponding to a second portion of the machine-readable instructions represented by the flowcharts of FIGS. 6, 7A, and 7B, and/or an ASIC may be configured and/or structured to perform third operation(s)/function(s) corresponding to a third portion of the machine-readable instructions represented by the flowcharts of FIGS. 6, 7A, and 7B.

It should be understood that some or all of the circuitry of FIGS. 3 and/or 4 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIGS. 3 and/or 4 may be instantiated, for example, in one or more threads executing concurrently and/or in series. For example, the microprocessor 1100 of FIG. 11 may execute machine-readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIGS. 3 and/or 4 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

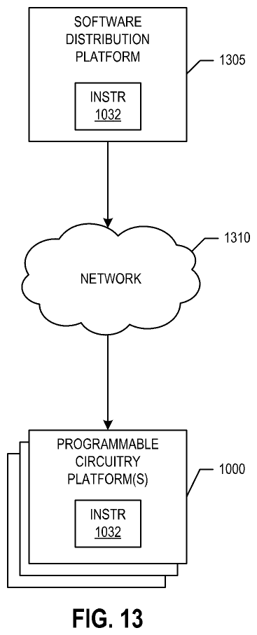

A block diagram illustrating an example software distribution platform 1305 to distribute software such as the example machine-readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine-readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine-readable instructions of FIGS. 6, 7A, and 7B, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1032 from the software distribution platform 1305. For example, the software, which may correspond to the example machine-readable instructions of FIGS. 6, 7A, and 7B, may be downloaded to the example programmable circuitry platform 1000, which is to execute the machine-readable instructions 1032 to implement the I/O network circuitry 310, the programmable circuitry 312, the caching agent circuitry 314, the memory controller circuitry 316, and/or the load balancer circuitry 318. In some examples, one or more servers of the software distribution platform 1305 periodically offer, transmit, and/or force updates to the software (e.g., the example machine-readable instructions 1032 of FIG. 10) to ensure improvements, patches, updates, etc., are distributed and applied to the software at the end user devices. Although referred to as software above, the distributed “software” could alternatively be firmware.

The instructions 1032 may be transmitted or received over the network 1310 using a transmission medium via the interface circuitry 1020 of FIG. 10 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and/or wireless data networks (e.g., Institute of Electrical and Electronics Engineers (IEEE) 802.11 family of standards known as Wi-Fi®), IEEE 802.15.4 family of standards, peer-to-peer (P2P) networks, among others.

A computing program may be written in any form of programming language, including compiled or interpreted languages, and it may be deployed in any form, including as a stand-alone program and/or as a module, component, subroutine, and/or other unit suitable for use in a computing environment. Also, programs, codes, and/or code segments for accomplishing the techniques described herein are construed as within the scope of the present disclosure by programmers of ordinary skill in the art.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Use of a singular reference (e.g., “a,” “an,” “one or more,” “at least one,” etc.) to describe multiple structures, components, items, objects, and/or things does not imply that the same number of instances of the multiple structures, components, items, objects, and/or things are implemented. For example, when “at least one” is used to describe an API (e.g., at least one API) and also used to refer to a characteristic (e.g., at least one characteristic), use of “at least one” does not imply that the number of APIs and the number of characteristics is equal.

Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” “fourth,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs), one or more microcontrollers that may execute first instructions to perform one or more operations and/or functions, and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc. References to circuitry (e.g., circuitry, first circuitry, second circuitry, etc.) can be programmable circuitry or non-programmable circuitry.

From the foregoing, it will be appreciated that example systems, apparatus, articles of manufacture, and methods have been disclosed that schedule algorithms based on characteristics of data to be operated upon. For example, disclosed systems, apparatus, articles of manufacture, and methods analyze data objects (e.g., as the data objects are transferred into a compute device (e.g., via a network card) or created inside the compute device (e.g., at a programmable circuit)). Additionally, examples disclosed herein tag data objects with corresponding characteristics (e.g., level of sparsity) based on such analysis. Examples disclosed herein also determine, at runtime, which hardware is the best to be used to implement an algorithm based on an SLO for handling a data object (e.g., a set of data objects), at least one characteristic of the data object identified in corresponding metadata of the data object, and substantially real time utilization of hardware (e.g., one or more programmable circuits) of the compute device.

As described herein, different implementations of an algorithm provide different execution KPIs depending on the hardware selected to execute the algorithm to process data. By analyzing data objects, tagging the data objects with metadata indicative of corresponding characteristics of the data objects, and monitoring telemetry data of the hardware, examples disclosed herein facilitate scheduling of such data objects on hardware in accordance with a particular SLO specified by software. Accordingly, examples disclosed herein include data type modelling in-memory and inline compute with memory object tagging.

Disclosed systems, apparatus, articles of manufacture, and methods improve the efficiency of using a computing device by scheduling algorithms on hardware to satisfy one or more SLOs and/or one or more SLAs for data objects to be processed by one or more algorithms. For example, disclosed systems, apparatus, articles of manufacture, and methods select a programmable circuit (e.g., the best, optimal, most efficient, most performant, etc. programmable circuit) to implement an algorithm to process a given data object. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to schedule algorithms based on characteristics of data are disclosed herein. Further examples and combinations thereof include the following:

Example 1 includes a compute device comprising circuitry to determine at least one characteristic of a data object to be processed, and adjust metadata associated with the data object to indicate that the data object has the at least one characteristic, machine-readable instructions, and at least one programmable circuit to be programmed by the machine-readable instructions to select at least one of two or more programmable circuits to process the data object based on (a) at least one service level objective associated with the data object, (b) the metadata associated with the data object, and (c) telemetry data associated with the two or more programmable circuits.

Example 2 includes the compute device of example 1, wherein the circuitry is to register a data stream to determine information identifying respective starts and ends of data objects of the data stream, detect, based on the information, a start of the data object and an end of the data object in the data stream to detect the data object, and determine the at least one characteristic of the data object based on detection of the data object.

Example 3 includes the compute device of example 2, wherein the circuitry is to decrypt the data stream based on a cryptographic key stored at the circuitry.

Example 4 includes the compute device of any of examples 1, 2, or 3, wherein the two or more programmable circuits include a first programmable circuit and a second programmable circuit, the first circuitry includes memory controller circuitry, and the memory controller circuitry is to access a first portion of the data object from the first programmable circuit, access a second portion of the data object from the second programmable circuit, and analyze the first portion of the data object and the second portion of the data object to determine the at least one characteristic of the data object.

Example 5 includes the compute device of any of examples 1, 2, 3, or 4, wherein the circuitry includes memory controller circuitry, and the memory controller circuitry is to based on a request to analyze the data object, access the data object from memory, and analyze the data object to determine whether to update the at least one characteristic indicated by the metadata.

Example 6 includes the compute device of example 5, wherein the memory includes a first memory and a second memory, and the circuitry is to access a first portion of the data object from the first memory, and access a second portion of the data object from the second memory.

Example 7 includes the compute device of any of examples 1, 2, 3, 4, 5, or 6, wherein the machine-readable instructions are first machine-readable instructions, and one or more of the at least one programmable circuit is to access a data structure that maps second machine-readable instructions to (1) respective types of the two or more programmable circuits and (2) at least one key performance indicator (KPI) for the respective types of the two or more programmable circuits, and access the telemetry data associated with the two or more programmable circuits, wherein selection of the at least one of the two or more programmable circuits is based on the at least one service level objective associated with the data object, the at least one KPI for the respective types of the two or more programmable circuits, the metadata associated with the data object, and the telemetry data.

Example 8 includes a non-transitory computer-readable medium comprising instruction to cause at least one programmable circuit to determine at least one characteristic of a data object to be processed, adjust metadata associated with the data object to indicate that the data object has the at least one characteristic, and select at least one of first hardware circuitry or second hardware circuitry to process the data object based on (a) at least one service level objective associated with the data object, (b) the metadata associated with the data object, and (c) telemetry data associated with the first hardware circuitry and the second hardware circuitry.

Example 9 includes the non-transitory computer-readable medium of example 8, wherein the instructions are to cause one or more of the at least one programmable circuit to register a data stream to determine information identifying respective starts and ends of data objects of the data stream, detect, based on the information, a start of the data object and an end of the data object in the data stream to detect the data object, and determine the at least one characteristic of the data object based on detection of the data object.

Example 10 includes the non-transitory computer-readable medium of example 9, wherein the instructions are to cause one or more of the at least one programmable circuit to decrypt the data stream based on a cryptographic key.

Example 11 includes the non-transitory computer-readable medium of any of examples 8, 9, or 10, wherein the instructions are to cause one or more of the at least one programmable circuit to access a first portion of the data object from the first hardware circuitry, access a second portion of the data object from the second hardware circuitry, and analyze the first portion of the data object and the second portion of the data object to determine the at least one characteristic of the data object.

Example 12 includes the non-transitory computer-readable medium of any of examples 8, 9, 10, or 11, wherein the instructions are to cause one or more of the at least one programmable circuit to based on a request to analyze the data object, access the data object from memory, and analyze the data object to determine whether to update the at least one characteristic indicated by the metadata.

Example 13 includes the non-transitory computer-readable medium of example 12, wherein the memory includes a first memory and a second memory, and the instructions are to cause one or more of the at least one programmable circuit to access a first portion of the data object from the first memory, and access a second portion of the data object from the second memory.

Example 14 includes the non-transitory computer-readable medium of any of examples 8, 9, 10, 11, 12, or 13, wherein the instructions are first instructions, and the first instructions are to cause one or more of the at least one programmable circuit to access a data structure that maps second instructions to (1) respective types of the first hardware circuitry and the second hardware circuitry and (2) at least one key performance indicator (KPI) for the respective types of the first hardware circuitry and the second hardware circuitry, and access the telemetry data associated with the first hardware circuitry and the second hardware circuitry, wherein selection of the at least one of the first hardware circuitry or the second hardware circuitry is based on the at least one service level objective associated with the data object, the at least one KPI for the respective types of the first hardware circuitry and the second hardware circuitry, the metadata associated with the data object, and the telemetry data.

Example 15 includes a method comprising determining, with circuitry, at least one characteristic of a data object to be processed, adjusting, with the circuitry, metadata associated with the data object to indicate that the data object has the at least one characteristic, and selecting, by executing at least one instruction with at least one programmable circuit, at least one of two or more programmable circuits to process the data object based on (a) at least one service level objective associated with the data object, (b) the metadata associated with the data object, and (c) telemetry data associated with the two or more programmable circuits.

Example 16 includes the method of example 15, further including registering a data stream to determine information identifying respective starts and ends of data objects of the data stream, detecting, based on the information, a start of the data object and an end of the data object in the data stream to detect the data object, and determining the at least one characteristic of the data object based on detection of the data object.

Example 17 includes the method of example 16, further including decrypting the data stream based on a cryptographic key.

Example 18 includes the method of any of examples 15, 16, or 17, wherein the two or more programmable circuits include a first programmable circuit and a second programmable circuit, and the method further includes accessing a first portion of the data object from the first programmable circuit, accessing a second portion of the data object from the second programmable circuit, and analyzing the first portion of the data object and the second portion of the data object to determine the at least one characteristic of the data object.

Example 19 includes the method of any of examples 15, 16, 17, or 18, further including based on a request to analyze the data object, accessing the data object from memory, and analyzing the data object to determine whether to update the at least one characteristic indicated by the metadata.

Example 20 includes the method of example 19, wherein the memory includes a first memory and a second memory, and the method includes accessing a first portion of the data object from the first memory, and accessing a second portion of the data object from the second memory.

Example 21 includes the method of any of examples 15, 16, 17, 18, 19, or 20, wherein the at least one instruction is at least one first instruction, and the method includes accessing a data structure that maps at least one second instruction to (1) respective types of the two or more programmable circuits and (2) at least one key performance indicator (KPI) for the respective types of the two or more programmable circuits, and accessing the telemetry data associated with the two or more programmable circuits, wherein selection of the at least one of the two or more programmable circuits is based on the at least one service level objective associated with the data object, the at least one KPI for the respective types of the two or more programmable circuits, the metadata associated with the data object, and the telemetry data.

Example 22 includes a compute device comprising means for determining at least one characteristic of a data object to be processed, means for tagging the data object to adjust metadata associated with the data object to indicate that the data object has the at least one characteristic, and means for selecting at least one of two or more programmable circuits to process the data object based on (a) at least one service level objective associated with the data object, (b) the metadata associated with the data object, and (c) telemetry data associated with the two or more programmable circuits.

Example 23 includes the compute device of example 22, wherein the means for tagging is to register a data stream to determine information identifying respective starts and ends of data objects of the data stream, and detect, based on the information, a start of the data object and an end of the data object in the data stream to detect the data object, and the means for determining is to determine the at least one characteristic of the data object based on detection of the data object.

Example 24 includes the compute device of example 23, further including means for decrypting the data stream based on a cryptographic key.

Example 25 includes the compute device of any of examples 22, 23, or 24, wherein the two or more programmable circuits include a first programmable circuit and a second programmable circuit, and the means for tagging is to access a first portion of the data object from the first programmable circuit, and access a second portion of the data object from the second programmable circuit, and the means for determining is to analyze the first portion of the data object and the second portion of the data object to determine the at least one characteristic of the data object.

Example 26 includes the compute device of any of examples 22, 23, 24, or 25, wherein the means for determining is to based on a request to analyze the data object, access the data object from memory, and analyze the data object to determine whether to update the at least one characteristic indicated by the metadata.

Example 27 includes the compute device of example 26, wherein the memory includes a first memory and a second memory, and the means for tagging is to access a first portion of the data object from the first memory, and access a second portion of the data object from the second memory.

Example 28 includes the compute device of any of examples 22, 23, 24, 25, 26, or 27, wherein the means for selecting is to access a data structure that maps machine-readable instructions to (1) respective types of the two or more programmable circuits and (2) at least one key performance indicator (KPI) for the respective types of the two or more programmable circuits, and access the telemetry data associated with the two or more programmable circuits, wherein selection of the at least one of the two or more programmable circuits is based on the at least one service level objective associated with the data object, the at least one KPI for the respective types of the two or more programmable circuits, the metadata associated with the data object, and the telemetry data.

Example 29 includes a compute device comprising circuitry to determine respective characteristic of data objects to be stored in memory, and adjust respective metadata associated with the data objects to indicate that the data objects have the respective characteristics, machine-readable instructions, and at least one first programmable circuit to be programmed by the machine-readable instructions to, based on a request from at least one second programmable circuit access the memory to determine at least one data object that has a target characteristic, the target characteristic specified in the request, and return a pointer to the at least one data object to the at least one second programmable circuit.

Example 30 includes the compute device of example 29, wherein the data objects include a first data object, the circuitry includes memory controller circuitry, and the memory controller circuitry is to access a first portion of the first data object from a third programmable circuit, access a second portion of the first data object from a fourth programmable circuit, and analyze the first portion of the first data object and the second portion of the first data object to determine at least one characteristic of the first data object.

Example 31 includes the compute device of any of examples 29 or 30, wherein the request is a first request, the data objects include a first data object, the respective metadata is respective first metadata, the circuitry includes memory controller circuitry, and the memory controller circuitry is to based on a second request to analyze the first data object, access the first data object from memory, and analyze the first data object to determine whether to update at least one characteristic indicated by second metadata of the first data object.

Example 32 includes the compute device of example 31, wherein the memory includes a first memory and a second memory, and the circuitry is to access a first portion of the first data object from the first memory, and access a second portion of the first data object from the second memory.

Example 33 includes the compute device of any of examples 29, 30, 31, or 32, wherein the data objects are first data objects, the respective metadata is respective first metadata, the request specifies a memory range in the memory, and one or more of the at least one first programmable circuit is to access second data objects stored in the memory range, and determine whether respective second metadata associated with the second data objects indicates that any of the second data objects has the target characteristic.

Example 34 includes the compute device of example 33, wherein one or more of the at least one first programmable circuit is to, based on none of the second data objects having the target characteristic, notify the at least one second programmable circuit that none of the second data objects have the target characteristic.

Example 35 includes the compute device of example 33, wherein the second data objects include the at least one data object, and one or more of the at least one first programmable circuit is to, based on the at least one second programmable circuit being permitted to access the at least one data object, return the pointer to the at least one second programmable circuit.

Example 36 includes a non-transitory computer-readable medium comprising instruction to cause at least one first programmable circuit to determine respective characteristic of data objects to be stored in memory, adjust respective metadata associated with the data objects to indicate that the data objects have the respective characteristics, based on a request from at least one second programmable circuit access the memory to determine at least one data object that has a target characteristic, the target characteristic specified in the request, and return a pointer to the at least one data object to the at least one second programmable circuit.

Example 37 includes the non-transitory computer-readable medium of example 36, wherein the data objects include a first data object, and the instructions are to cause one or more of the at least one first programmable circuit to access a first portion of the first data object from a third programmable circuit, access a second portion of the first data object from a fourth programmable circuit, and analyze the first portion of the first data object and the second portion of the first data object to determine at least one characteristic of the first data object.

Example 38 includes the non-transitory computer-readable medium of any of examples 36 or 37, wherein the request is a first request, the data objects include a first data object, the respective metadata is respective first metadata, and the instructions are to cause one or more of the at least one first programmable circuit to based on a second request to analyze the first data object, access the first data object from memory, and analyze the first data object to determine whether to update at least one characteristic indicated by second metadata of the first data object.

Example 39 includes the non-transitory computer-readable medium of example 38, wherein the memory includes a first memory and a second memory, and the instructions are to cause one or more of the at least one first programmable circuit to access a first portion of the first data object from the first memory, and access a second portion of the first data object from the second memory.

Example 40 includes the non-transitory computer-readable medium of any of examples 36, 37, 38, or 39, wherein the data objects are first data objects, the respective metadata is respective first metadata, the request specifies a memory range in the memory, and the instructions are to cause one or more of the at least one first programmable circuit to access second data objects stored in the memory range, and determine whether respective second metadata associated with the second data objects indicates that any of the second data objects has the target characteristic.

Example 41 includes the non-transitory computer-readable medium of example 40, wherein the instructions are to cause one or more of the at least one first programmable circuit to, based on none of the second data objects having the target characteristic, notify the at least one second programmable circuit that none of the second data objects have the target characteristic.

Example 42 includes the non-transitory computer-readable medium of example 40, wherein the second data objects include the at least one data object, and the instructions are to cause one or more of the at least one first programmable circuit to, based on the at least one second programmable circuit being permitted to access the at least one data object, return the pointer to the at least one second programmable circuit.

Example 43 includes a method comprising determining, by executing an instruction with at least one first programmable circuit, respective characteristic of data objects to be stored in memory, adjusting, by executing an instruction with the at least one first programmable circuit, respective metadata associated with the data objects to indicate that the data objects have the respective characteristics, based on a request from at least one second programmable circuit accessing, by executing an instruction with the at least one first programmable circuit, the memory to determine at least one data object that has a target characteristic, the target characteristic specified in the request, and returning, by executing an instruction with the at least one first programmable circuit, a pointer to the at least one data object to the at least one second programmable circuit.

Example 44 includes the method of example 43, wherein the data objects include a first data object, and the method includes accessing a first portion of the first data object from a third programmable circuit, accessing a second portion of the first data object from a fourth programmable circuit, and analyzing the first portion of the first data object and the second portion of the first data object to determine at least one characteristic of the first data object.

Example 45 includes the method of any of examples 43 or 44, wherein the request is a first request, the data objects include a first data object, the respective metadata is respective first metadata, and the method includes based on a second request to analyze the first data object, accessing the first data object from memory, and analyzing the first data object to determine whether to update at least one characteristic indicated by second metadata of the first data object.

Example 46 includes the method of example 45, wherein the memory includes a first memory and a second memory, and the method includes accessing a first portion of the first data object from the first memory, and accessing a second portion of the first data object from the second memory.

Example 47 includes the method of any of examples 43, 44, 45, or 46, wherein the data objects are first data objects, the respective metadata is respective first metadata, the request specifies a memory range in the memory, and the method includes accessing second data objects stored in the memory range, and determining whether respective second metadata associated with the second data objects indicates that any of the second data objects has the target characteristic.

Example 48 includes the method of example 47, including, based on none of the second data objects having the target characteristic, notifying the at least one second programmable circuit that none of the second data objects have the target characteristic.

Example 49 includes the method of example 47, wherein the second data objects include the at least one data object, and the method includes, based on the at least one second programmable circuit being permitted to access the at least one data object, returning the pointer to the at least one second programmable circuit.

Example 50 includes a compute device comprising means for determining respective characteristic of data objects to be stored in memory, means for tagging the data objects to adjust respective metadata associated with the data object to indicate that the data objects have the respective characteristics, and means for identifying at least one data object having a target characteristic based on a request from at least one programmable circuit, the means for identifying to access the memory to determine the at least one data object that has the target characteristic, the target characteristic specified in the request, and return a pointer to the at least one data object to the at least one programmable circuit.

Example 51 includes the compute device of example 50, wherein the data objects include a first data object, and the means for tagging is to access a first portion of the first data object from a first programmable circuit, access a second portion of the first data object from a second programmable circuit, and the means for determining is to analyze the first portion of the first data object and the second portion of the first data object to determine at least one characteristic of the first data object.

Example 52 includes the compute device of any of examples 50 or 51, wherein the request is a first request, the data objects include a first data object, the respective metadata is respective first metadata, and the means for determining is to based on a second request to analyze the first data object, access the first data object from memory, and analyze the first data object to determine whether to update at least one characteristic indicated by second metadata of the first data object.

Example 53 includes the compute device of example 52, wherein the memory includes a first memory and a second memory, and the means for tagging is to access a first portion of the first data object from the first memory, and access a second portion of the first data object from the second memory.

Example 54 includes the compute device of any of examples 50, 51, 52, or 53, wherein the data objects are first data objects, the respective metadata is respective first metadata, the request specifies a memory range in the memory, and the means for identifying is to access second data objects stored in the memory range, and determine whether respective second metadata associated with the second data objects indicates that any of the second data objects has the target characteristic.

Example 55 includes the compute device of example 54, wherein the means for identifying is to, based on none of the second data objects having the target characteristic, notify the at least one programmable circuit that none of the second data objects have the target characteristic.

Example 56 includes the compute device of example 54, wherein the second data objects include the at least one data object, and the means for identifying is to, based on the at least one programmable circuit being permitted to access the at least one data object, return the pointer to the at least one programmable circuit.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1.-28. (canceled)

29. A compute device comprising:
circuitry to:
respectively determine one or more characteristics of one or more data objects to be stored in memory; and
adjust one or more metadata respectively associated with the one or more data objects to indicate that the one or more data objects respectively have the one or more characteristics;
machine-readable instructions; and
at least one first programmable circuit to be programmed by the machine-readable instructions to, based on a request from at least one second programmable circuit:
access the memory to determine at least one of the one or more data objects has a target characteristic, the target characteristic specified in the request; and
return a pointer to the at least one of the one or more data objects to the at least one second programmable circuit.

30. The compute device of claim 29, wherein the at least one of the one or more data objects is a first data object, the circuitry includes memory controller circuitry, and the memory controller circuitry is to:
access a first portion of the first data object from a third programmable circuit;
access a second portion of the first data object from a fourth programmable circuit; and
analyze the first portion of the first data object and the second portion of the first data object to determine the one or more characteristics of the first data object.

31. The compute device of claim 29, wherein the request is a first request, the at least one of the one or more data objects is a first data object, the one or more metadata includes first metadata associated with the first data object, the circuitry includes memory controller circuitry, and the memory controller circuitry is to:
based on a second request to analyze the first data object, access the first data object from memory; and
analyze the first data object to determine whether to update the one or more characteristics indicated by the first metadata.

32. The compute device of claim 31, wherein the memory includes a first memory and a second memory, and the circuitry is to:
access a first portion of the first data object from the first memory; and
access a second portion of the first data object from the second memory.

33. The compute device of claim 29, wherein the request specifies a memory range in the memory, and one or more of the at least one first programmable circuit is to:
access the one or more data objects stored in the memory range; and
determine whether the one or more metadata associated with the one or more data objects indicates that any of the one or more data objects has the target characteristic.

34. The compute device of claim 33, wherein one or more of the at least one first programmable circuit is to, based on none of the one or more data objects having the target characteristic, notify the at least one second programmable circuit that none of the one or more data objects have the target characteristic.

35. The compute device of claim 33, wherein one or more of the at least one first programmable circuit is to, based on the at least one second programmable circuit being permitted to access the at least one of the one or more data objects, return the pointer to the at least one second programmable circuit.

36. A non-transitory computer-readable medium comprising instructions to cause at least one first programmable circuit to:
respectively determine one or more characteristics of one or more data objects to be stored in memory;
adjust one or more metadata respectively associated with the one or more data objects to indicate that the one or more data objects respectively have the one or more characteristics;
based on a request from at least one second programmable circuit:
access the memory to determine at least one of the one or more data objects has a target characteristic, the target characteristic specified in the request; and
return a pointer to the at least one of the one or more data objects to the at least one second programmable circuit.

37. The non-transitory computer-readable medium of claim 36, wherein the at least one of the one or more data objects is a first data object, and the instructions are to cause one or more of the at least one first programmable circuit to:
access a first portion of the first data object from a third programmable circuit;
access a second portion of the first data object from a fourth programmable circuit; and
analyze the first portion of the first data object and the second portion of the first data object to determine the one or more characteristics of the first data object.

38. The non-transitory computer-readable medium of claim 36, wherein the request is a first request, the at least one of the one or more data objects is a first data object, the one or more metadata includes first metadata associated with the first data object, and the instructions are to cause one or more of the at least one first programmable circuit to:
based on a second request to analyze the first data object, access the first data object from memory; and
analyze the first data object to determine whether to update the one or more characteristics indicated by the first metadata.

39. The non-transitory computer-readable medium of claim 38, wherein the memory includes a first memory and a second memory, and the instructions are to cause one or more of the at least one first programmable circuit to:
access a first portion of the first data object from the first memory; and
access a second portion of the first data object from the second memory.

40. The non-transitory computer-readable medium of claim 36, wherein the request specifies a memory range in the memory, and the instructions are to cause one or more of the at least one first programmable circuit to:
access the one or more data objects stored in the memory range; and
determine whether the one or more metadata associated with the one or more data objects indicates that any of the one or more data objects has the target characteristic.

41. The non-transitory computer-readable medium of claim 40, wherein the instructions are to cause one or more of the at least one first programmable circuit to, based on none of the one or more data objects having the target characteristic, notify the at least one second programmable circuit that none of the one or more data objects have the target characteristic.

42. The non-transitory computer-readable medium of claim 40, wherein the instructions are to cause one or more of the at least one first programmable circuit to, based on the at least one second programmable circuit being permitted to access the at least one of the one or more data objects, return the pointer to the at least one second programmable circuit.

43.-49. (canceled)

50. A compute device comprising:
means for respectively determining one or more characteristics of one or more data objects to be stored in memory;
means for tagging the one or more data objects to adjust one or more metadata associated with the one or more data objects to indicate that the one or more data objects respectively have the one or more characteristics; and
means for identifying at least one of the one or more data objects having a target characteristic based on a request from at least one programmable circuit, the means for identifying to:
access the memory to determine the at least one of the one or more data objects ohas the target characteristic, the target characteristic specified in the request; and
return a pointer to the at least one of the one or more data objects to the at least one programmable circuit.

51. The compute device of claim 50, wherein the at least one of the one or more data objects is a first data object, and:
the means for tagging is to:
access a first portion of the first data object from a first programmable circuit;
access a second portion of the first data object from a second programmable circuit; and
the means for respectively determining is to analyze the first portion of the first data object and the second portion of the first data object to determine the one or more characteristics of the first data object.

52. The compute device of claim 50, wherein the request is a first request, the at least one of the one or more data objects is a first data object, the one or more metadata includes first metadata associated with the first data object, and the means for respectively determining is to:
based on a second request to analyze the first data object, access the first data object from memory; and
analyze the first data object to determine whether to update the one or more characteristics indicated by the first metadata.

53.-56. (canceled)

57. The compute device of claim 29, wherein the at least one of the one or more data objects is a first data object, the one or more metadata includes first metadata associated with the first data object, and one or more of the at least one first programmable circuit is to, based on the request:
access an initial line of a region of the memory in which the first data object is stored to determine the first metadata associated with the first data object; and
determine whether the first metadata indicates that the first data object has the target characteristic.

58. The compute device of claim 29, wherein one or more of the at least one first programmable circuit is to, based on communication with the at least one second programmable circuit:
determine a listing of different types of data objects stored in the memory; and
return the listing of the different types of data objects to the at least one second programmable circuit.

59. The compute device of claim 29, wherein the one or more data objects are included in a data stream, the at least one of the one or more data objects is a first data object, and the circuitry is to:
register the data stream to determine information identifying respective starts and ends of the one or more data objects of the data stream;
detect, based on the information, a start of the first data object and an end of the first data object in the data stream to detect the first data object; and
determine at least one characteristic of the first data object based on detection of the first data object.

60. The compute device of claim 59, wherein the circuitry is to decrypt the data stream based on a cryptographic key stored at the circuitry.

61. The compute device of claim 29, wherein the at least one of the one or more data objects is a first data object, the one or more metadata includes first metadata associated with the first data object, and one or more of the at least one first programmable circuit is to select at least one of two or more programmable circuits to process the first data object based on (a) at least one service level objective associated with the first data object, (b) the first metadata, and (c) telemetry data associated with the two or more programmable circuits.

62. The compute device of claim 61, wherein the machine-readable instructions are first machine-readable instructions, and one or more of the at least one first programmable circuit is to:
access a data structure that maps second machine-readable instructions to (1) respective types of the two or more programmable circuits and (2) at least one key performance indicator (KPI) for the respective types of the two or more programmable circuits; and
access the telemetry data associated with the two or more programmable circuits, wherein selection of the at least one of the two or more programmable circuits is based on the at least one service level objective, the at least one KPI for the respective types of the two or more programmable circuits, the first metadata, and the telemetry data.

63. The compute device of claim 29, wherein the one or more data objects include at least one of an image data object, a person data object, a product data object, an event data object, or a telecommunications data object.

64. The compute device of claim 29, wherein the one or more characteristics include at least one of one or more levels of sparsity of the one or more data objects or one or more sizes of the one or more data objects.

65. The compute device of claim 29, wherein the one or more characteristics include one or more data types of the one or more data objects, one or more creation dates of the one or more data objects, one or more modification dates of the one or more data objects, geolocation data for the one or more data objects, one or more access control lists for the one or more data objects, one or more encryption statuses of the one or more data objects, one or more checksums or hash values of the one or more data objects, one or more digital signatures for the one or more data objects, one or more file permissions for the one or more data objects, audit trail information for the one or more data objects, ownership information for the one or more data objects, one or more environmental contexts for the one or more data objects, or one or more data loss prevention tags for the one or more data objects.
